(19) United States
(12) Patent Application Publication
(10) Pub. No.: US 2019/0095175 A1
(43) Pub. Date: Mar. 28, 2019

(54) ARITHMETIC PROCESSING DEVICE AND ARITHMETIC PROCESSING METHOD

(71) Applicant: FUJITSU LIMITED, Kawasaki-shi (JP)

(72) Inventors: Ryosuke YAMANAKA, Kawasaki (JP); MAKIKO ITO, Kawasaki (JP)

(73) Assignee: FUJITSU LIMITED, Kawasaki-shi (JP)

(21) Appl. No.: 16/129,841

(22) Filed: Sep. 13, 2018

(30) Foreign Application Priority Data
Sep. 22, 2017 (JP) 2017-182797

(51) Int. Cl. G06F 7/575; G06F 17/18; G06F 7/499

(52) U.S. Cl. CPC G06F 7/575; G06F 7/49947; G06F 17/18

(57) ABSTRACT

There is provided an arithmetic processing device including a memory, and a processor coupled to the memory and the processor configured to calculate input data of an operation target so as to obtain data of an operation result, generate statistical information data for indicating a bit distribution in the data of the operation result, extract attention area data with a first predetermined size from the statistical information data, based on specified position information, generate higher-order side summary data obtained by summarizing higher-order side data of the statistical information data except the attention area data into a second predetermined size, and generate lower-order side summary data obtained by summarizing lower-order side data of the statistical information data except the attention area data into a third predetermined size.

### CROSS-REFERENCE TO RELATED APPLICATION

This application is based upon and claims the benefit of priority of the prior Japanese Patent Application No. 2017-182797, filed on Sep. 22, 2017, the entire contents of which are incorporated herein by reference.

### FIELD

The embodiments discussed herein are related to an arithmetic processing device and an arithmetic processing method.

### BACKGROUND

Among the mechanical learning methods using artificial intelligence, in particular, a need for deep learning has been increasing. In the deep learning, various operations including a multiplication, a product-sum operation, and a vector multiplication are executed. Meanwhile, in the deep learning, a requirement for an individual operational accuracy is not as precise as a normal arithmetic processing. For example, in a normal arithmetic processing, a programmer develops a computer program such that an overflow is not generated as much as possible. Meanwhile, in the deep learning, it may be allowable that large values are saturated to some extent. This is because, in the deep learning, an adjustment of a coefficient (weight) at the time of a convolution operation of a plurality of input data pieces is a main processing, and thus, in many cases, extreme data among input data is not emphasized. Also, since a large amount of data pieces are repeatedly used to adjust a coefficient, when an adjustment of digits is performed according to the progress of learning, the data that was once saturated may also be reflected in the coefficient adjustment without being saturated.

Therefore, in consideration of such characteristics of deep learning, in order to reduce the chip area of an arithmetic processing device for deep learning and improve the power consumption performance, using an integer operation by a fixed-point number without using a floating-point number may be taken into consideration. This is because a circuit configuration may be more simplified by an integer operation by a fixed-point number, as compared to a floating-point number operation.

However, the fixed-point number has a narrow dynamic range of possible values, and thus an operational accuracy of the fixed-point number may be deteriorated as compared to that of the floating-point number. Accordingly, even in the deep learning, a consideration is required on the accuracy that allows the largest possible value to the smallest possible value to be expressed, that is, a consideration is required on valid digits. Thus, a technique in which the fixed-point number is expanded has been suggested.

For example, in a processing by a mixed fixed point, a unified decimal point position is not used for a program in its entirety, but a decimal point position (Q format) suitable for each variable is used. For example, a Q3.12 format defines data of 16 bits including 1 digit for a sign bit, 3 digits for an integer part, and 12 digits below a decimal point. In the mixed fixed point, it is possible to perform a processing by varying a decimal point position for each variable, that is, digits of an integer part and digits below a decimal point.

In another example, in a processing by a dynamic fixed point (a dynamic fixed-point number), a value range of a variable is acquired during execution, and a decimal point position is reviewed at a fixed timing. Accordingly, it may be said that in the mixed fixed-point operation and the dynamic fixed-point operation, aspects of the floating decimal point operation are added to the fixed-point operation that allows a simple processing as compared to the floating decimal point operation.

Also, there has been proposed a digital signal processor (DSP) that has a function for a program for executing a processing by a mixed fixed-point operation and a dynamic fixed-point operation. For example, there is a DSP that executes a block-shift designation operation instruction. In the block-shift designation operation instruction, an operation is performed with a bit width larger than a bit width of a variable, and a value from an operation result is extracted by shifting, and stored in a register for the variable. By this instruction, the shift amount S (e.g., −128 to 127) when the value is extracted from the operation result may be designated by an immediate value/general-purpose register. For example, when the DSP executes an instruction of Result=Saturate(((in1(operator)in2)>>S), 16), the operation result is shifted by S bits, and higher-order bits are saturated while lower-order 16 bits are left. When S≥0, the DSP arithmetically shifts the operation result to the right (that is, embeds a sign bit and shifts the operation result to the right), and then, removes the lower-order bits. Meanwhile, when S<0, the DSP arithmetically shifts the operation result to the left (e.g., maintains a sign bit, and shifts the operation result to the left), and removes the lower-order bits in the complement.

Related technologies are disclosed in, for example, Japanese Laid-Open Patent Publication No. 07-084975.

### SUMMARY

According to an aspect of the invention, an arithmetic processing device includes a memory, and a processor coupled to the memory and the processor configured to calculate input data of an operation target so as to obtain data of an operation result, generate statistical information data for indicating a bit distribution in the data of the operation result, extract attention area data with a first predetermined size from the statistical information data, based on specified position information, generate higher-order side summary data obtained by summarizing higher-order side data of the statistical information data except the attention area data into a second predetermined size, and generate lower-order side summary data obtained by summarizing lower-order side data of the statistical information data except the attention area data into a third predetermined size.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating distribution data of unsigned most significant bit positions;

FIG. 2 is an example of a processing of decimal point position update by Comparative Example;

FIG. 3 is a view illustrating a configuration of a processor of an information processing apparatus of Comparative Example;

FIG. 4 illustrates a circuit block of the processor of Comparative Example;

FIG. 5 is a view illustrating a specific configuration of a data converter;

FIG. 6 is a view illustrating a truth table of a statistical information acquisition unit;

FIG. 7 is a view illustrating a logic circuit that outputs output bits 0 to 38 in the statistical information acquisition unit that generates a distribution of unsigned most significant bit positions;

FIG. 8 illustrates a logic circuit that outputs an output bit 39 in the statistical information acquisition unit that generates a distribution of unsigned most significant bit positions;

FIG. 9 is a view illustrating a configuration of a hardware circuit of the statistical information acquisition unit that acquires an unsigned least significant bit position;

FIG. 10 is a view illustrating a processing of a statistical information aggregating unit;

FIG. 11 is a view illustrating a configuration of a hardware circuit of the statistical information aggregating unit;

FIG. 12 is a view illustrating a processing of the statistical information aggregating unit that aggregates bit positions by an OR operation;

FIG. 13 is a view illustrating a configuration of a hardware circuit of the statistical information aggregating unit that aggregates bit positions by an OR operation;

FIG. 14 is a view illustrating a configuration of a statistical information storage;

FIG. 15 is a view illustrating statistical information including four bit areas according to a first embodiment;

FIG. 16 is a view illustrating a second instruction format;

FIG. 17 is a view illustrating a circuit block of a processor according to the first embodiment;

FIG. 18 is a view illustrating a configuration of a statistical information summarizing unit according to the first embodiment;

FIG. 19 is a view illustrating a configuration of a window bit extraction circuit;

FIG. 20 is a view illustrating a configuration of a higher-order bit-side summary circuit;

FIG. 21 is a view illustrating a truth table of a higher-order side mask bit generator;

FIG. 22 is an example of a decoder with 6 inputs and 40 outputs;

FIG. 23 is an example of a mask pattern circuit that generates a higher-order side mask pattern based on outputs of the decoder;

FIG. 24 is a view illustrating a configuration of a lower-order bit-side summary circuit;

FIG. 25 is a view illustrating a truth table of a lower-order side mask bit generator;

FIG. 26 is an example of a mask pattern circuit that generates a lower-order side mask pattern;

FIG. 27 is a view illustrating a data flow between the statistical information acquisition unit, the statistical information summarizing unit, the statistical information aggregating unit, and the statistical information storage in the first embodiment;

FIG. 28 is a view illustrating a configuration of the statistical information aggregating unit that aggregates a distribution of unsigned most significant bit positions and a distribution of unsigned least significant bit positions;

FIG. 29 is a view illustrating a configuration of the statistical information aggregating unit that aggregates a maximum value of unsigned most significant bit positions and a minimum value of unsigned least significant bit positions;

FIG. 30 is a view illustrating a processing in a second embodiment; and

FIG. 31 is a view illustrating a configuration of an attention area summarizing unit that summarizes an attention area.

### DESCRIPTION OF EMBODIMENTS

In the related art, a scheme is suggested to reduce an operational accuracy deterioration of a fixed-point operation. However, in the related art, an arithmetic processing device that performs an operation was not able to efficiently acquire determination materials used for reducing the operational accuracy deterioration of the fixed-point operation.

### First Embodiment

Hereinafter, descriptions will be made on an embodiment of a technology capable of improving an accuracy of a fixed-point number, and reducing a physical quantity and a power consumption of a circuit, with reference to the drawings.

In the present embodiment, a processor 10 of an information processing apparatus acquires statistical information related to a distribution of numerical values as an operation execution result and provides the statistical information to, for example, an application program. Here, the statistical information related to the distribution of numerical values refers to, for example, any one of the following (1) to (4), or a combination thereof. The application program executed by the information processing apparatus acquires the statistical information from the processor, thereby optimizing a decimal point position. According to the processing of the application program, the processor executes instructions for a dynamic fixed-point operation or a mixed fixed-point operation.

(1) Distribution of Unsigned Most Significant Bit Positions

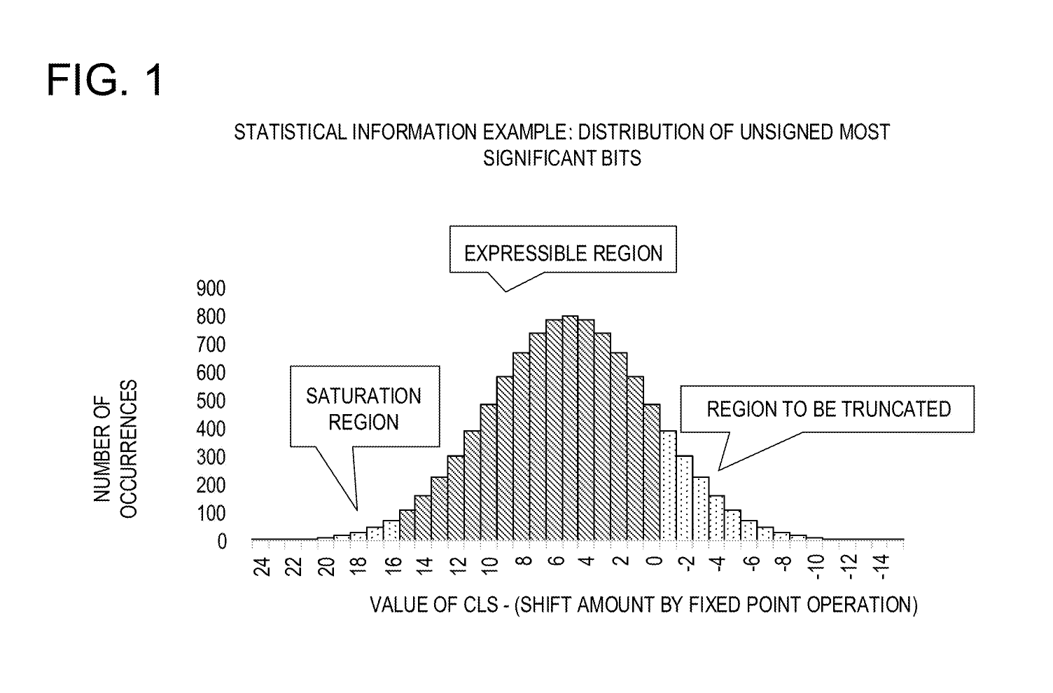

FIG. 1 illustrates distribution data of unsigned most significant bit positions. FIG. 1 corresponds to an example on data shifted to the right by 14 bits for the purpose of a digit alignment of a fixed-point number, in which an intermediate result of an operation is 40 bits. The unsigned most significant bit position refers to a most significant bit position where the bit is 1 for a positive number, and refers to a most significant bit position where the bit is 0 for a negative number. The unsigned most significant bit position indicates, for example, a bit position having the largest index k among bits[k] different from a sign bit bit[39] when bits are arranged from the most significant bit bit[39] to the least significant bit bit[0]. When a distribution of the unsigned most significant bit positions is obtained, it becomes possible to grasp a distribution range of values as absolute values.

In FIG. 1, the vertical axis indicates the number of occurrences of an unsigned most significant bit position, and the horizontal axis indicates a position count leading sign (CLS) of a most significant bit. In FIG. 1, it is assumed that there is a decimal point on the right side of bit 0. In the present embodiment, an arithmetic circuit of the processor of the information processing apparatus and a register within the arithmetic circuit have a bit width (e.g., 40 bits) equal to or greater than the number of bits (e.g., 16 bits) of a register specified by an operand of an instruction. Meanwhile, the bit width of the arithmetic circuit of the processor of the information processing apparatus and the register within the arithmetic circuit is not limited to 40 bits. The operation result is stored in a register (e.g., a register specified by an operand of an instruction) having a smaller bit width than the arithmetic circuit, such as, for example, a register of 16 bits. As a result, the operation result (e.g., 40 bits) is shifted by a shift amount specified by the operand. Then, bits corresponding to bits less than bit 0 are subjected to a predetermined rounding processing, and data (e.g., data exceeding bit 15) exceeding the bit width of the register specified by the operand is saturated.

The numerical values given to the horizontal axis in FIG. 1 are examples of numerical values that may be represented by fixed decimal points. Among these, positions from 0 to 15 correspond to values of a fixed-point number of 16 bits, respectively. Here, for example, when the information processing apparatus shifts the fixed-point number by −2 bits (shifts to the right by 2 bits), the most significant bit shifts to a position of 14. Then, a region to be saturated is extended by 2 bits (the higher order side is reduced by 2 bits), and a region which becomes 0 by occurrence of an underflow is reduced by 2 bits (numbers below a decimal point are extended by 2 bits). That is, when the information processing apparatus shifts a decimal point position to the left by 2 bits, the region to be saturated is extended by 2 bits, and the region in which an underflow occurs is reduced by 2 bits. Conversely, for example, when the information processing apparatus shifts the fixed-point number by 2 bits in the positive direction (shifts to the left by 2 bits), the most significant bit shifts to a position of 18. Then, a region to be saturated is reduced by 2 bits, and a region where an underflow occurs is extended by 2 bits. That is, when the information processing apparatus shifts a decimal point position to the right by 2 bits, the region to be saturated is reduced by 2 bits, and the region in which an underflow occurs is extended by 2 bits.

The information processing apparatus may obtain a distribution of unsigned most significant bit positions during learning execution so as to immediately determine a proper shift amount in a dynamic fixed-point operation or a mixed fixed-point operation, that is, a proper fixed decimal point position. For example, the information processing apparatus may determine the fixed decimal point position such that a ratio of data to be saturated becomes a specified ratio or less. That is, in an example, the information processing apparatus may determine the fixed decimal point position by prioritizing that data is saturated to a predetermined extent rather than that an underflow of data is performed to a predetermined extent.

The distribution of the unsigned most significant bit positions is integrated within a predetermined register (also, referred to as a statistical information register) within the processor of the information processing apparatus. The processor executes commands such as reading and writing of distribution data from/to the corresponding statistical information register, and clearing of the statistical information register. Thus, in the statistical information register, distribution data on one or more fixed-point numbers that become command execution targets from the time of execution of a previous-time clear command to the present time is accumulated. The accumulated distribution data is read to a memory by a read command. The processor may execute a command to perform loading into the statistical information register, instead of the clear command, so that a value 0 may be loaded in the statistical information register.

(2) Distribution of Unsigned Least Significant Bit Positions

The distribution of unsigned least significant bit positions indicates a least significant bit position where a bit has a value different from a sign bit. For example, the least significant bit position indicates a bit position having the smallest index k among bits[k] different from a sign bit, bit[39], when bits are arranged from the most significant bit, bit[39], to the least significant bit, bit[0]. In the distribution of the unsigned least significant bit positions, least significant bits included in valid data are grasped.

(3) Maximum Value of Unsigned Most Significant Bit Positions

A maximum value of unsigned most significant bit positions is the maximum value among most significant bit positions having different values from a sign bit, with respect to one or more fixed point numbers that become command execution targets from the time of execution of a previous-time clear command to the present time. The information processing apparatus may use the maximum value of the unsigned most significant bit positions in determining a proper shift amount in a dynamic fixed-point operation, that is, a proper decimal point position.

The processor executes commands such as reading of the maximum value from the statistical information register, and clearing of the statistical information register. Therefore, in the statistical information register, maximum values from the execution of the previous-time clear command to the present time are accumulated, and the maximum values are read to the memory by a read command.

(4) Minimum Value of Unsigned Least Significant Bit Positions

A minimum value of unsigned least significant bit positions is the minimum value among least significant bit positions having different values from a sign bit, with respect to one or more fixed point numbers from the time of execution of a previous-time clear command to the present time. The information processing apparatus may use the minimum value of the unsigned least significant bit positions in determining a proper shift amount in a dynamic fixed-point operation, that is, a proper decimal point position.

The processor 10 executes commands such as reading and clearing of the minimum value from the statistical information register. Accordingly, in the statistical information register, the minimum values from the execution of the previous-time clear command to the present time are accumulated, and then, are read to the memory by a read command.

### Comparative Example

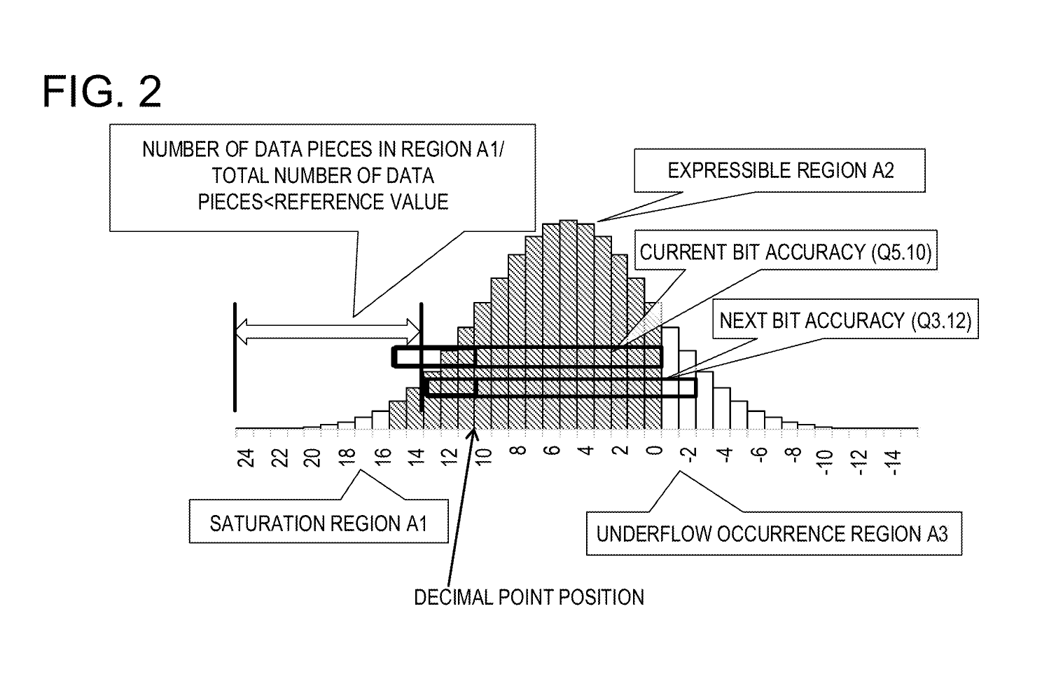

FIG. 2 illustrates a processing example of a decimal point position update by Comparative Example. The drawing indicates, for example, a distribution of unsigned most significant bit positions. In the drawing, it is assumed that there is a decimal point between bit 11 and bit 10. Here, a fixed-point number is described as Q5.10 (5 digits in the integer part, 10 digits after the decimal point), and it is assumed that a saturation region A1, an expressible region A2, and an underflow occurrence region A3 are formed. In this example, the saturation region A1 and the underflow occurrence region A3 are illustrated as an open frequency distribution. The expressible region is indicated by a shaded hatching pattern. In this example, a frequency distribution of the underflow occurrence region is higher than a frequency distribution of the saturation region, and thus a balance is bad. Meanwhile, even in the case where the decimal point position is moved downward by 2 bits, that is, in the case of Q3.12 (3 digits of the integer part, 12 digits after the decimal point), the value obtained by dividing the number of data pieces in the saturation region by the total number of data pieces becomes less than a target reference value. Therefore, the information processing apparatus may continue to perform a processing by re-setting the decimal point position from Q5.10 to Q3.12. That is, the information processing apparatus in Comparative Example determines the next bit accuracy from statistical information through the following procedures.

(Procedure 1) The information processing apparatus acquires statistical information with a current bit accuracy, and creates any one of above histograms (1) to (4). In the statistical information in the case of (3) and (4), an OR operation is performed on data of a flag string indicating collected unsigned bit positions (most significant bit positions, least significant bit positions) to create a frequency distribution with a maximum frequency of 1.

(Procedure 2) The information processing apparatus calculates, with respect to the above statistical information in (1), a bit accuracy at which the ratio of the number of overflowing data pieces with respect to the total number of data pieces in the histogram becomes a threshold rmax. Alternatively, the information processing apparatus calculates, with respect to the above statistical information (2), a bit accuracy at which the ratio of the number of underflowing data pieces with respect to the total number of data pieces in the histogram becomes a threshold rmax. In the case of the above statistical information (2) and (4), a bit accuracy is calculated by setting a threshold rmax to 0. That is, a bit accuracy is updated to match with the maximum value (minimum value) of unsigned most significant (least significant) bits.

(Procedure 3) An operation in the next period is performed with the calculated bit accuracy.

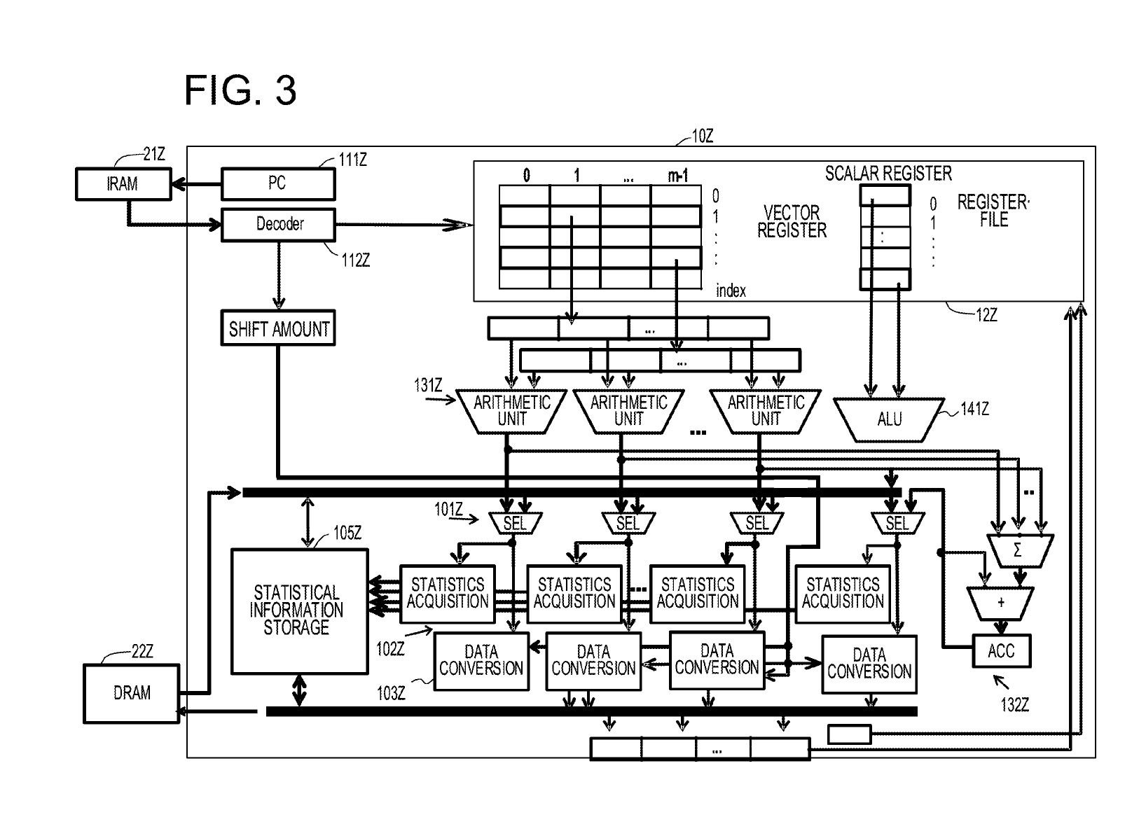

FIG. 3 illustrates a configuration of a processor 10Z in the information processing apparatus of Comparative Example. In FIG. 3, together with the processor 10Z, an instruction memory (IRAM) 21Z and a data memory (DRAM) 22Z are illustrated. The processor 10Z is an arithmetic processing device capable of executing a single instruction multiple data (SIMD)-type operation instruction.

The processor 10Z includes a program counter (PC) 111Z, a decoder 112Z, a register file 12Z, a vector operation arithmetic unit 131Z, a scalar operation arithmetic unit (arithmetic logic unit (ALU)) 141Z, and an accumulator 132Z that adds the result of the vector operation arithmetic unit 131Z. Further, the processor 10Z includes a plurality of selectors 101Z that select operation results of, for example, the vector operation arithmetic unit 131Z, the scalar operation arithmetic unit 141Z, and the accumulator 132Z and read results from the data memory 22Z. In the drawing, a plurality of selectors are collectively referred to as the selector 101Z. A plurality of vector operation arithmetic units are collectively referred to as the arithmetic unit 131Z.

The processor 10Z includes a statistical information acquisition unit 102Z that acquires statistical information from data selected by the selector 101Z, and a statistical information storage 105Z that stores the statistical information acquired by the statistical information acquisition unit 102Z. In the drawing, a plurality of statistical information acquisition units are collectively referred to as the statistical information acquisition unit 102Z.

The processor 10Z includes a data converter 103Z that changes a fixed decimal point position of data selected by the selector 101Z. In the drawing, a plurality of data converters are collectively referred to as the data converter 103Z.

Referring to the drawing, an instruction is fetched from an address of the instruction memory 21Z indicated by the program counter 111Z, and the decoder 112Z decodes the fetched instruction. In the drawing, an instruction fetching controller that executes fetching of an instruction is omitted.

When the decoder 112Z decodes the instruction, respective units of the processor 10Z are controlled according to the decoded result. For example, when the decoded result is a vector operation instruction, data of a vector register of the register file 12Z is input to the vector operation arithmetic unit 131Z, and a vector operation is executed. The operation result of the vector operation arithmetic unit 131Z is supplied to the statistical information acquisition unit 102Z and the data converter 103Z through the selector 101Z. The operation result of the vector operation arithmetic unit 131Z is input to the accumulator 132Z, and the operation result of the vector operation arithmetic unit 131Z is added to, for example, a cascade. The operation result of the accumulator 132Z is supplied to the statistical information acquisition unit 102Z and the data converter 103Z through the selector 101Z.

For example, when, as a result of the decoding, the instruction is a scalar operation instruction, data of a scalar register of the register file 12Z is input to the scalar operation arithmetic unit 141Z. The operation result of the arithmetic unit 141Z is supplied to the statistical information acquisition unit 102Z and the data converter 103Z through the selector 101Z as in the operation result of the accumulator 132Z.

For example, when, as a result of decoding, the instruction is a load instruction, data is read from the data memory 22Z, and supplied to the statistical information acquisition unit 102Z and the data converter 103Z through the selector 101Z. The result of data conversion in the data converter 103Z is stored in the register of the register file 12Z.

When, as a result of decoding, the instruction is an instruction to execute a dynamic fixed-point operation, the decoder 112Z instructs a shift amount to be supplied to the data converter 103Z. The shift amount is acquired from, for example, an operand (immediate value) of an instruction, a register specified by an operand, and the data memory 22Z of an address indicated by an address register specified by an operand, etc., and is supplied to the data converter 103Z.

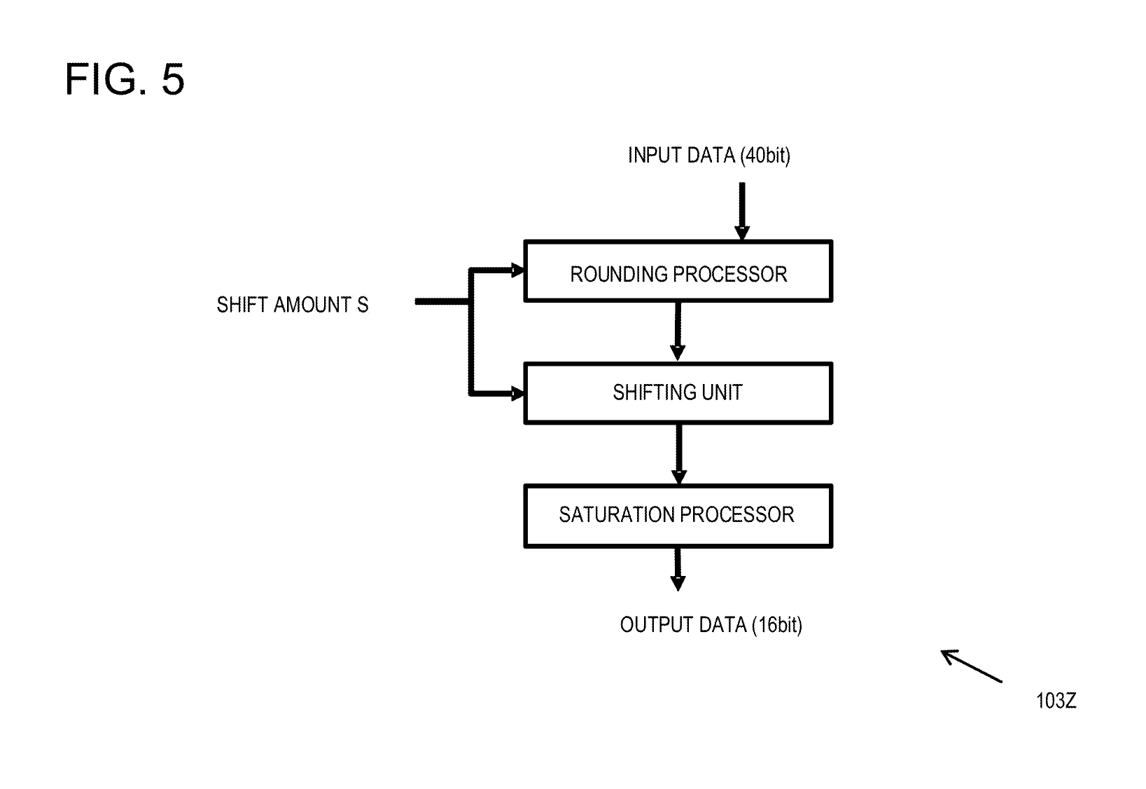

The data converter 103Z shifts fixed point number data obtained from, for example, the result of the vector operation, the result of the scalar operation, the operation result of the accumulator 132Z, or the result read from the data memory 22Z, by a specified shift amount S. The data converter 103Z executes not only shifting, but also a saturation processing of higher-order bits and a rounding of lower-order bits. FIG. 5 illustrates a specific configuration of the data converter 103Z. The data converter 103Z includes a rounding processor that rounds lower-order S bits as a decimal part, a shifting unit that executes arithmetic shifting, and a saturation processor that performs a saturation processing, with respect to, for example, an operation result of 40 bits as input.

The rounding processor rounds the lower-order S bits as a decimal part. When S is negative, the rounding processor does not perform anything. As for the rounding, for example, rounding to nearest, rounding to 0, rounding to positive infinity, rounding to negative infinity, and random number rounding are exemplified. In the drawing, the shift amount is a shift amount acquired from the instruction by the decoder 112Z, for example, as illustrated in FIG. 3. The shifting unit performs an arithmetic right shift by S bits when S is positive, and performs an arithmetic left shift, that is, an arithmetic left shift by −S bits when S is negative. The saturation unit outputs 2E15 with respect to a shift result equal to or greater than 2E15-1 (positive maximum value), outputs −2E15 with respect to a shift result equal to or less than −2E15 (negative minimum value), or otherwise, outputs lower-order 16 bits of the input. Here, 2E15 represents the fifteenth power of 2.

Then, the data converter 103Z maintains a sign of a higher-order bit at the time of the left shift, and performs a saturation processing on bits other than the sign bit. That is, the data converter 103Z discards a higher-order bit, and embeds 0 into a lower-order bit. At the time of the right shift, the data converter 103Z embeds a sign bit into a higher-order bit (a bit at a lower order than a sign bit). Then, the data converter 103Z outputs data obtained as described above through, rounding, shifting, and saturation processing, with the same bit width (e.g., a register of 16 bits) as, for example, a register of the register file 12Z.

Accordingly, a computer program executed by the processor 10Z specifies a shift amount in an operand of an instruction that executes a dynamic fixed-point operation so that the processor 10Z updates a decimal point position of a fixed-point number by the specified shift amount during program execution.

As a result of decoding, when the instruction is an instruction to acquire statistical information (referred to as an instruction with a statistical information acquisition function), the statistical information is acquired by the statistical information acquisition unit 102Z, and is stored in the statistical information storage 105Z. Here, the statistical information, as described above, is (1) a distribution of unsigned most significant bit positions, (2) a distribution of unsigned least significant bit positions, (3) a maximum value of unsigned most significant bit positions, (4) a minimum value of unsigned least significant bit positions, or a combination thereof.

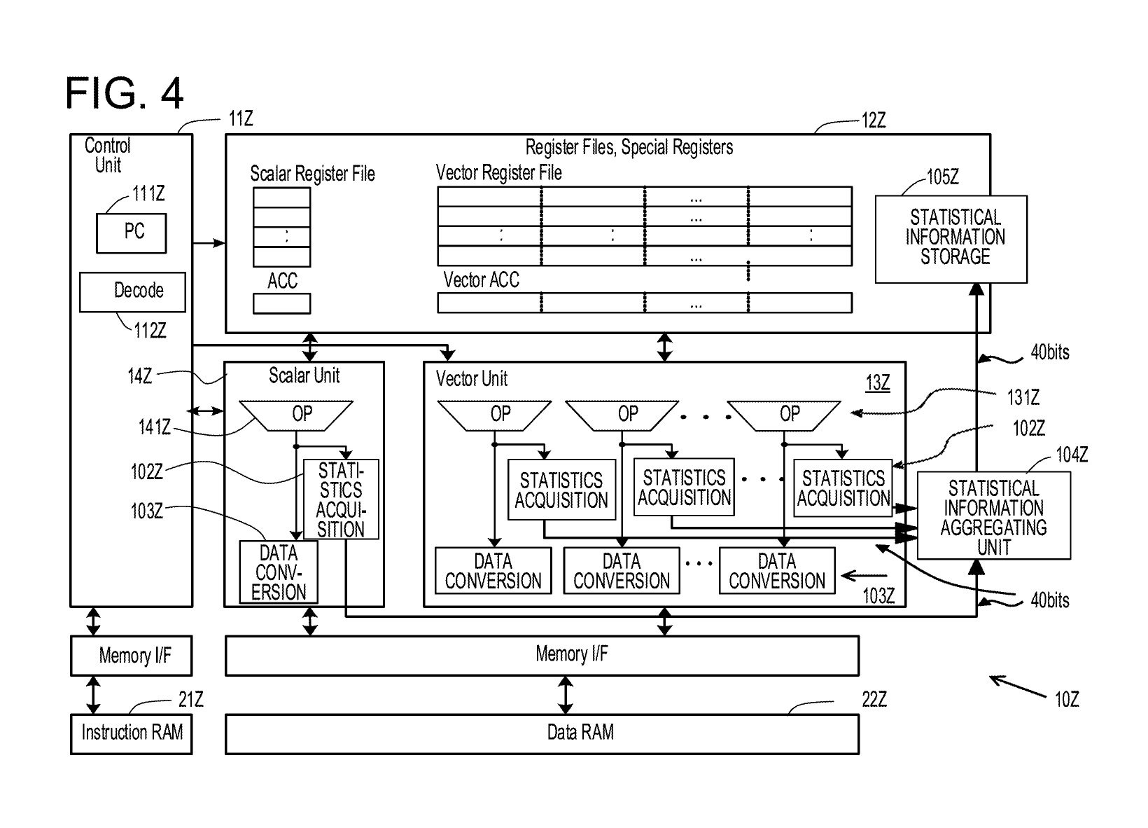

FIG. 4 illustrates a circuit block of the processor 10Z of Comparative Example. The processor 10Z includes a control unit 11Z, the register file 12Z, a vector unit 13Z, and a scalar unit 14Z. The control unit 11Z includes the program counter 111Z and the decoder 112Z. The register file includes a vector register file, an accumulator register (Vector ACC) for a vector operation, a scalar register file, and an accumulator register (ACC) for a scalar operation. The vector unit 13Z includes the vector operation arithmetic unit 131Z, the statistical information acquisition unit 102Z, and the data converter 103Z. The scalar unit 14Z includes the scalar operation arithmetic unit 141Z, the statistical information acquisition unit 102Z, and the data converter 103Z.

In the configuration example in FIG. 4, a statistical information aggregating unit 104Z that aggregates statistical information from the plurality of statistical information acquisition units 102Z is added. The statistical information storage 105Z is set as a part of the register file 12Z. The instruction memory 21Z is connected to the control unit 11Z via a memory interface (memory I/F). The data memory 22Z is connected to the vector unit 13Z and the scalar unit 14Z via a memory interface (memory I/F).

Hereinafter, among the statistical information acquisition units 102Z, a unit that acquires an unsigned most significant bit position will be referred to as a statistical information acquisition unit 102A. Among the statistical information acquisition units 102Z, a unit that acquires an unsigned least significant bit position will be referred to as a statistical information acquisition unit 102B. Among the statistical information aggregating units 104Z, a unit that counts bit positions acquired by the statistical information acquisition unit 102A and acquires a bit distribution with respect to the bit positions will be referred to as a statistical information aggregating unit 104A. Among the statistical information aggregating units 104Z, a unit that performs an OR operation on bit positions acquired by the statistical information acquisition unit 102B in a previous stage for acquiring a maximum value and a minimum value of bit positions will be referred to as a statistical information aggregating unit 104B.

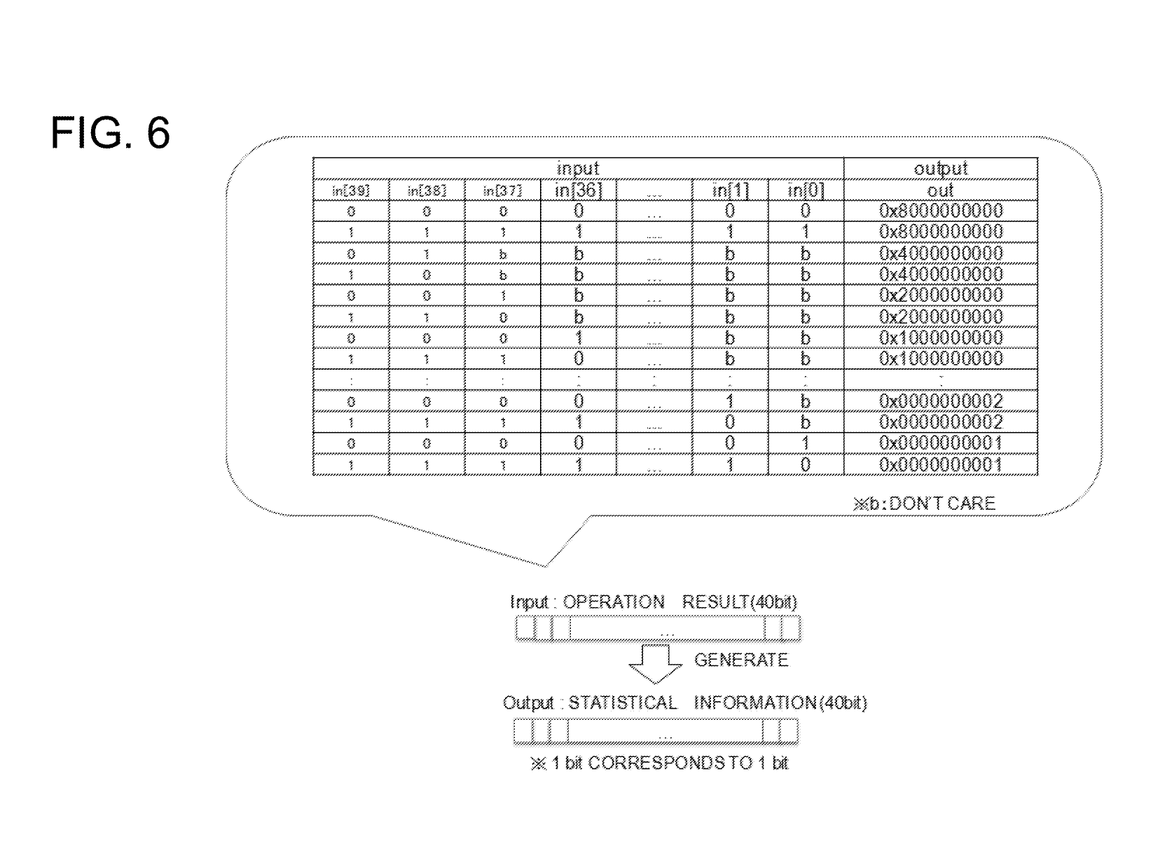

FIG. 6 illustrates a truth table of the statistical information acquisition unit 102A that generates a distribution of unsigned most significant bit positions in Comparative Example. In the truth table, for the inputs of all bits 0 or all bits 1, the most significant bit is 1, and other bits are 0 in output 40 bits. For the inputs other than the inputs of all bits 0 or all bits 1, a bit at the most significant position having a different bit value from a sign bit (in[39]) is 1, and other bits are 0. That is, among other bits (in[38:0]) except for the sign bit (in[39]), when there is no bit different from the sign bit, out[39] is 1. Among bits (in[38:0]) except for the sign bit (in[39]), when there is a bit different from the sign bit, out[39] is 0. That is, in the statistical information, the unsigned most significant bit position is indicated by bit 1, and bits at positions other than a position of the unsigned most significant bit are indicated by bit 0. Likewise, in other statistical information, that is, (2) an unsigned least significant bit position, (3) a maximum value of unsigned most significant bit positions, or (4) a minimum value of unsigned least significant bit positions is indicated by one bit 1 indicating each position in 40 bits, and bit 0 indicating other positions. In such statistical information, bit 1 indicating (1) the unsigned most significant bit position, (2) the unsigned least significant bit position, (3) the position of the maximum value of the unsigned most significant bit positions, or (4) the position of the minimum value of the unsigned least significant bit positions is called a flag.

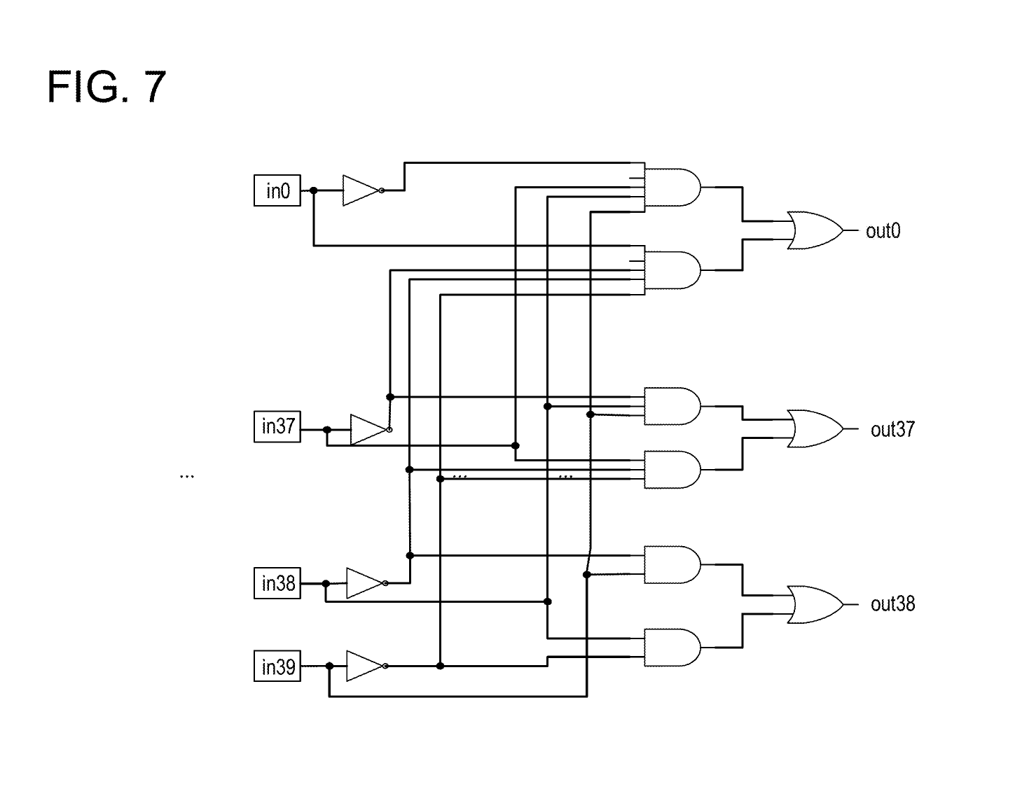

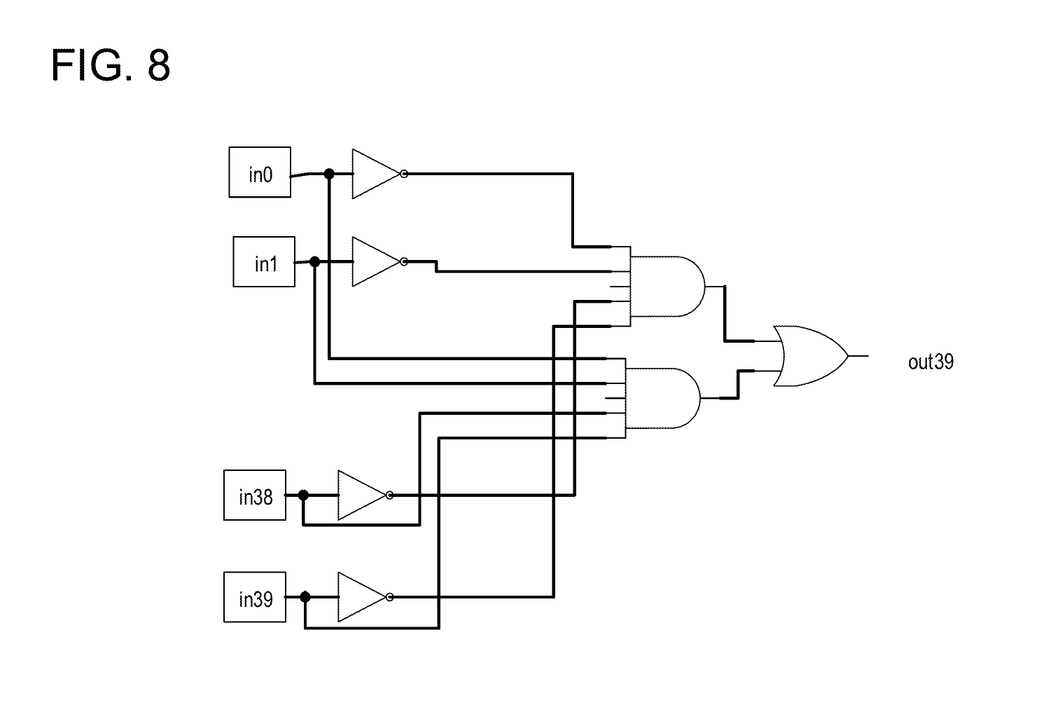

FIG. 7 illustrates a logic circuit that outputs output bits 0 to 38 in the statistical information acquisition unit 102A that generates a distribution of unsigned most significant bit positions in Comparative Example. FIG. 8 illustrates a logic circuit that outputs an output bit 39 in the statistical information acquisition unit 102A that generates a distribution of unsigned most significant bit positions in Comparative Example. As illustrated in FIG. 8, out39 is true when all of in0 to in39 are matched (0 or 1). Also, out39 is false when 0 and 1 are mixed in in0 to in39. As illustrated in FIG. 7, each of out0 to out38 is true when all the bits at the higher order than an input bit (called in*) having the same bit position as the corresponding bit are matched (0 or 1), and in* is different from the higher-order bits.

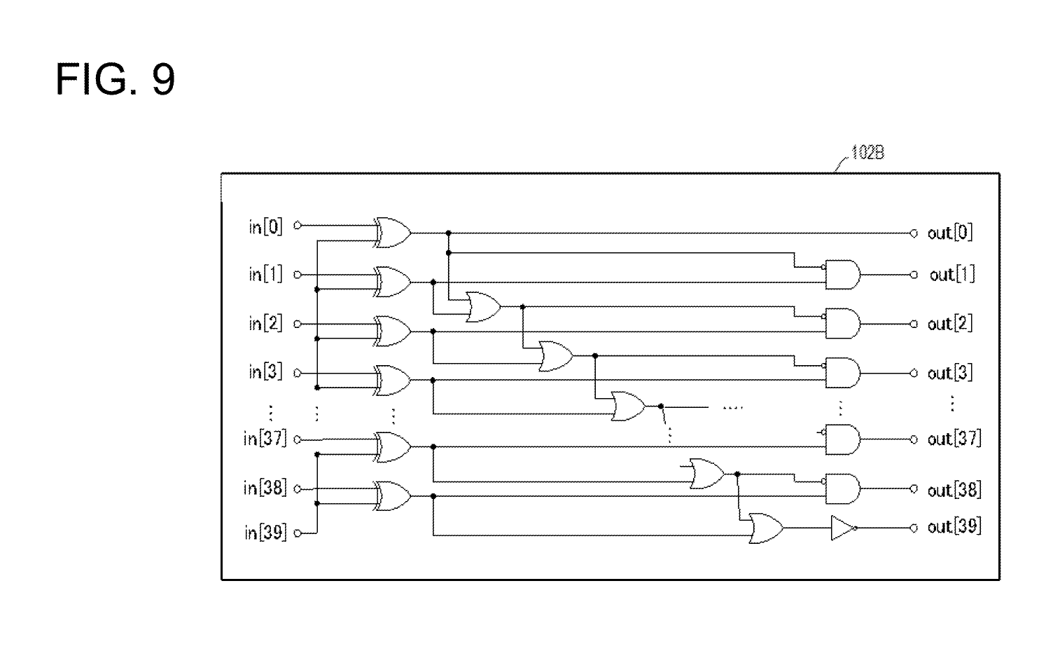

FIG. 9 illustrates a configuration of a hardware circuit in the statistical information acquisition unit 102B that acquires an unsigned least significant bit position. When the sign bit in[39] is 0, the statistical information acquisition unit 102B may search for a bit position where the bit is 1 from the least significant bit in[0] toward the higher-order side. Meanwhile, when the sign bit in[39] is 1, since data is complementary, the statistical information acquisition unit 102B may search for a bit position where the bit is 0 from the least significant bit in[0] toward the higher-order side.

That is, in this circuit, exclusive OR (EXOR) between the sign bit in[39] and other bits (in[0] to in[38]) is executed. Then, the exclusive OR value by a bit having the same value as the sign bit in[39] is 0, and the exclusive OR value by a bit having a different value from the sign bit in[39] is 1.

Here, for example, when in[0] and in[39] have different values, out[0] of data output by exclusive OR is 1. Meanwhile, the exclusive OR value of in[39] and in[1] is input to out[1] of the output data via an AND gate. To one input of the AND gate, a bit value obtained by inverting the exclusive OR value of in[39] and in[0] is input. Thus, when the exclusive OR value of in[39] and in[0] is 1, regardless of the exclusive OR value of in[39] and in[1], the output of the AND gate is 0.

Similarly, the exclusive OR value of in[39] and in[2] is input to out[2] of output data, via the same AND gate as above. To one input of the AND gate, a bit value obtained by inverting the logical sum (output of an OR gate) of two exclusive OR values, that is, the exclusive OR value of in[39] and in[0] and the exclusive OR value of in[39] and in[1], is input. Thus, when the exclusive OR value of in[39] and in[0] is 1, regardless of the exclusive OR value of in[39] and in[2], the output of the AND gate that outputs a value to out[2] of the output data is 0. Hereinafter, similarly, regardless of the exclusive OR value of in[39] and in[i] (i is 1 or more), the output of the AND gate that outputs a value to out[i] of the output data is 0.

Meanwhile, for example, when in[0] and in[39] have the same value, out[0] of data output by exclusive OR is 0. Thus, an AND gate to which the exclusive OR value of in[39] and in[1] is input outputs 1 or 0 depending on the exclusive OR value of in[39] and in[1]. Hereinafter, similarly, an input with logical NOT of the AND gate, from which out[i] (i is 1 or more) is output, is 0 when all the exclusive ORs of in[39] and in[j] (j is 0 or more, and i−1 or less) are 0. When the exclusive OR value of in[39] and in[i] (i is 1 or more) is 1, 1 is set to out[i]. 0 is set to output data out[i] at the higher order than the corresponding bit. Therefore, by the circuit of FIG. 9, output data out(40 bits) is acquired in which 1 is set to the unsigned least significant bit position, and other bits are 0.

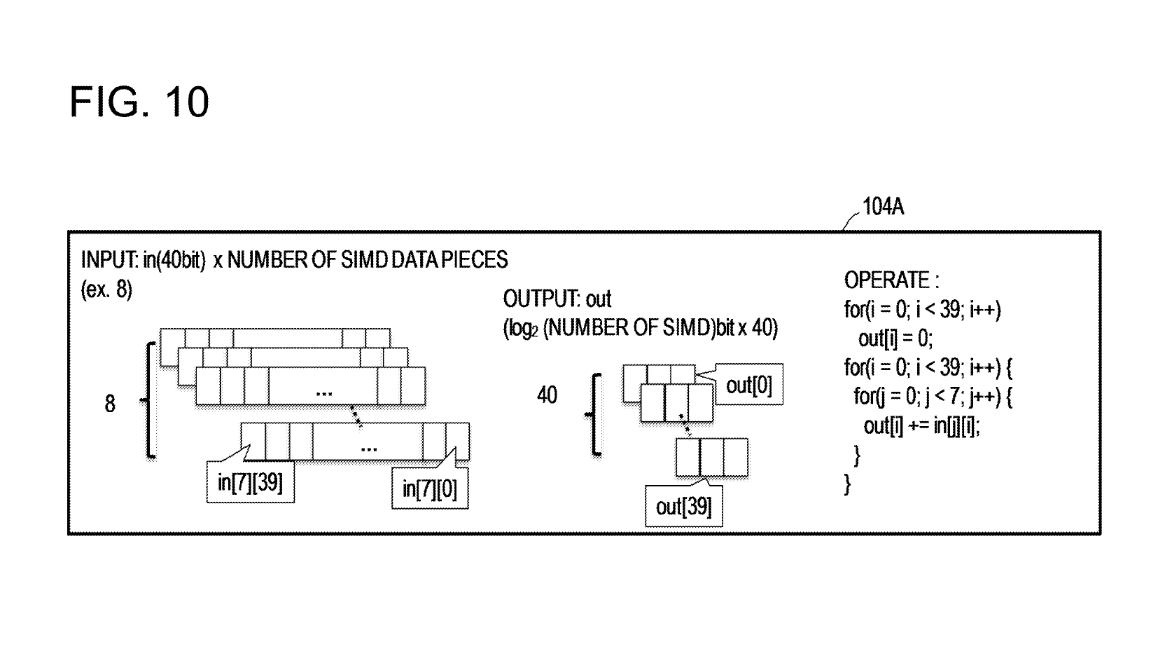

FIG. 10 is a view illustrating a processing of the statistical information aggregating unit 104A that acquires a distribution of bits from data acquired by the statistical information acquisition unit 102A. In the drawing, a processing of acquiring a distribution of bits from SIMD data in which eight pieces of 40-bit data are processed in parallel is exemplified. In FIG. 10, a processing of the statistical information aggregating unit 104A which is a hardware circuit is described in pseudo code.

That is, input data is exemplified as array data of 8 (rows)×40 (bits). The input data of 40 bits in each row is data of an unsigned most significant bit position (output of the statistical information acquisition unit 102A in FIGS. 7 and 8) or an unsigned least significant bit position (output of the statistical information acquisition unit 102B in FIG. 9). In this processing, with respect to 40-bit output data out, first, all the bits are cleared. Then, values of elements of each column i in the array in[j][i] of the input data are added with respect to all the rows (j=0 to 7). Therefore, in the pseudo code of FIG. 10, the output data (an array element) out[j] is an integer of log₂ (the number of SIMD data pieces) bits (3 bits in the example of FIG. 10). In FIG. 10, it is assumed that the number of SIMD data pieces (the number of data pieces processed in parallel) is 8, but the number of SIMD data pieces is not limited to 8.

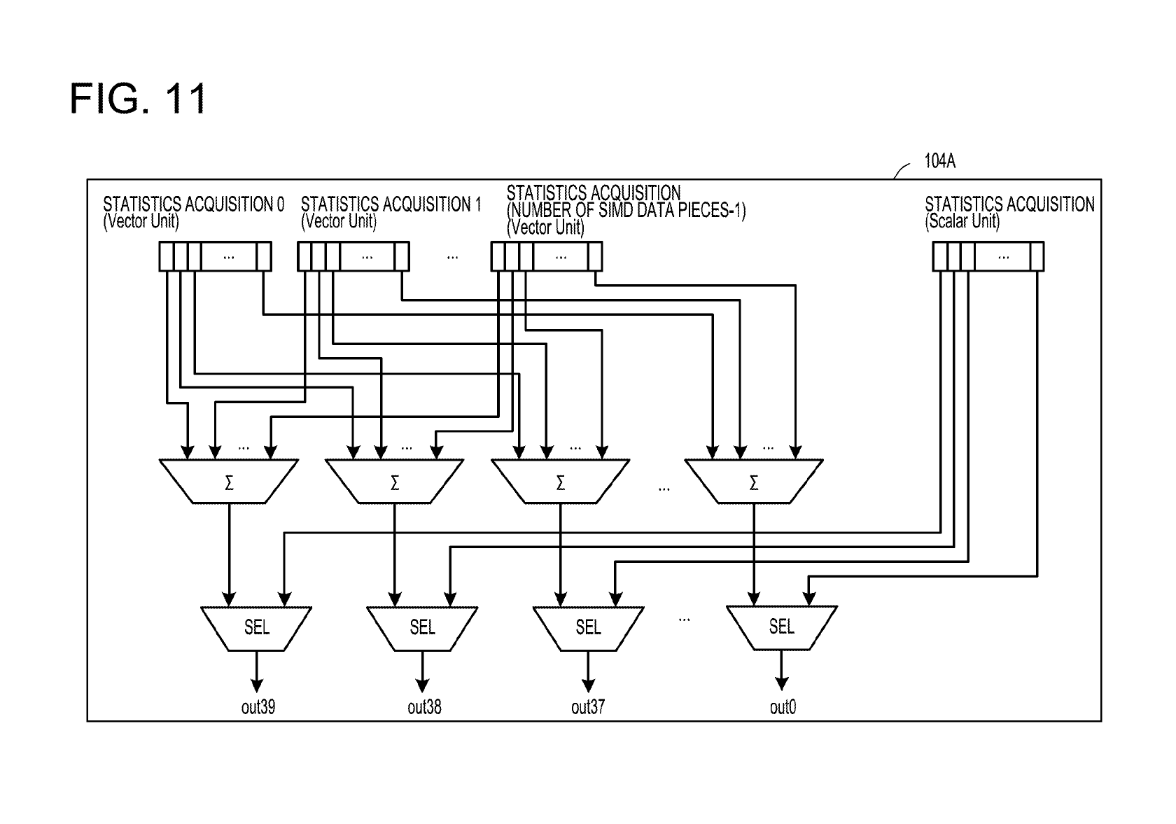

FIG. 11 illustrates a configuration of a hardware circuit of the statistical information aggregating unit 104A that acquires a distribution of bits from data acquired by the statistical information acquisition unit 102A. By a bit population count operation on data acquired by the statistical information acquisition unit 102A (here, statistics acquisition, the number of SIMD data pieces −1, from statistics acquisition, 0), the number of 1's is counted at the ith bits (i=0 to 39) in eight pieces of statistical information. The input data is, for example, an unsigned most significant bit position acquired by the statistical information acquisition unit 102A (FIGS. 7 and 8). Accordingly, the statistical information aggregating unit 104A counts the number of occurrences of ‘1’ at each bit with respect to unsigned most significant bit positions corresponding to the number of SIMD data pieces acquired by the statistical information acquisition unit 102A so as to count the number of occurrences of the most significant bit position. The statistical information aggregating unit 104A stores the count result in each of output data out0 to out39.

The input data may be set as an unsigned least significant bit position by the statistical information acquisition unit 102B (FIG. 9). The statistical information aggregating unit 104A counts the number of occurrences of ‘1’ at each bit with respect to unsigned least significant bit positions corresponding to the number of SIMD data pieces acquired by the statistical information acquisition unit 102B so as to count the number of occurrences of the least significant bit position. The statistical information aggregating unit 104A stores the count result in each of output data out0 to out39. That is, the statistical information aggregating unit 104A may process either the unsigned most significant bit positions or the unsigned least significant bit positions.

In FIG. 11, a selector SEL selects data acquired from a bit population count arithmetic unit(Σ) and a scalar unit 14. The data selected by the selector SEL is output to output data from out0 to out39. Therefore, data acquired by the statistical information acquisition unit 102A through the scalar unit 14 is output, as it is, to output data from out0 to out39 without being added in the operation of the scalar unit 14 at the first time. The output data out0 to out39 are data to be delivered to the statistical information storage 105Z.

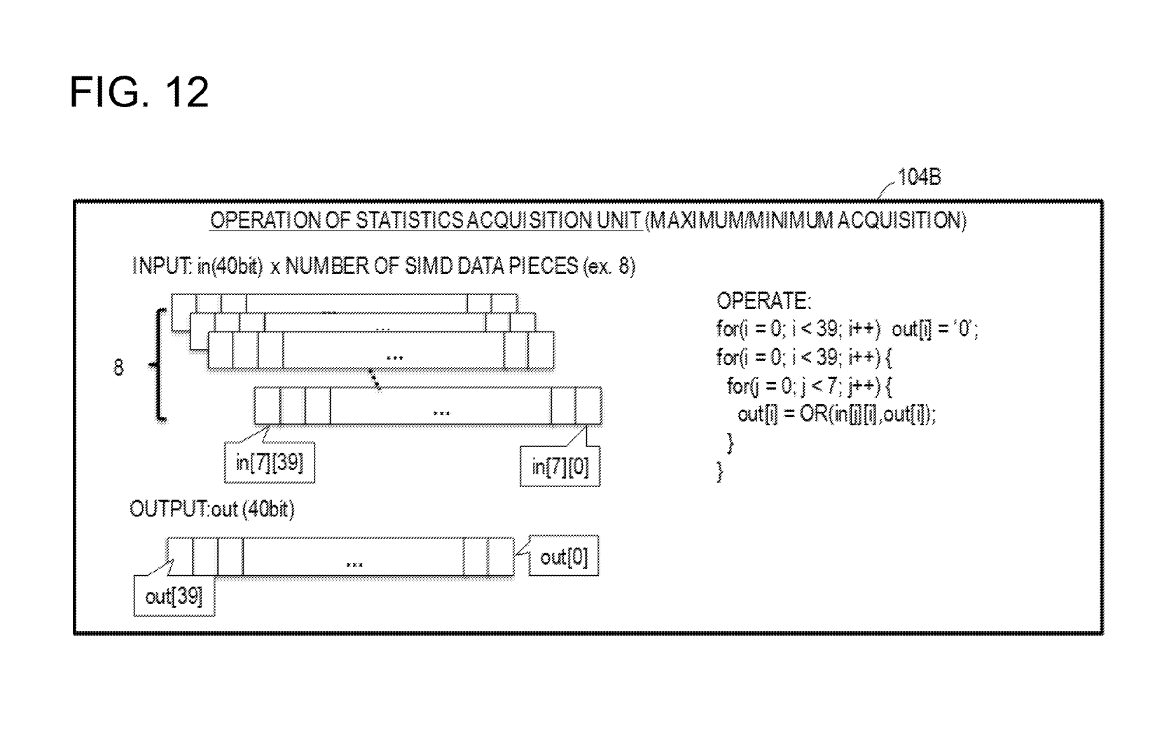

FIG. 12 is a view illustrating a processing of the statistical information aggregating unit 104B that aggregates bit positions by an OR operation as a precondition for acquiring a maximum value and a minimum value of bit positions from data acquired by the statistical information acquisition unit 102B. Also, in FIG. 12, as in FIG. 10, a processing on SIMD data in which eight pieces of 40-bit data are processed in parallel is exemplified. In FIG. 12, a processing of the statistical information aggregating unit 104B which is a hardware circuit is described in pseudo code.

In this processing, a result obtained through OR operations of each column in an array in[j][i] of input data, with respect to all the rows (j=0, . . . , 7), is input to 40-bit output data out[i] (i=0, . . . , 39). Accordingly, in the pseudo code of FIG. 12, unlike in the statistical information aggregating unit 104A of FIG. 10, the output data (an array element) out[i] (i=0, . . . , 39) is a bit string. As a result of the above processing, in the output data out[i] (i=0, . . . , 39), a bit position at which a value firstly becomes 1 in a direction from out[38] toward the lower-order bit is the maximum bit position. A bit position at which a value firstly becomes 1 in a direction from out[0] toward the higher-order bit is the minimum bit position.

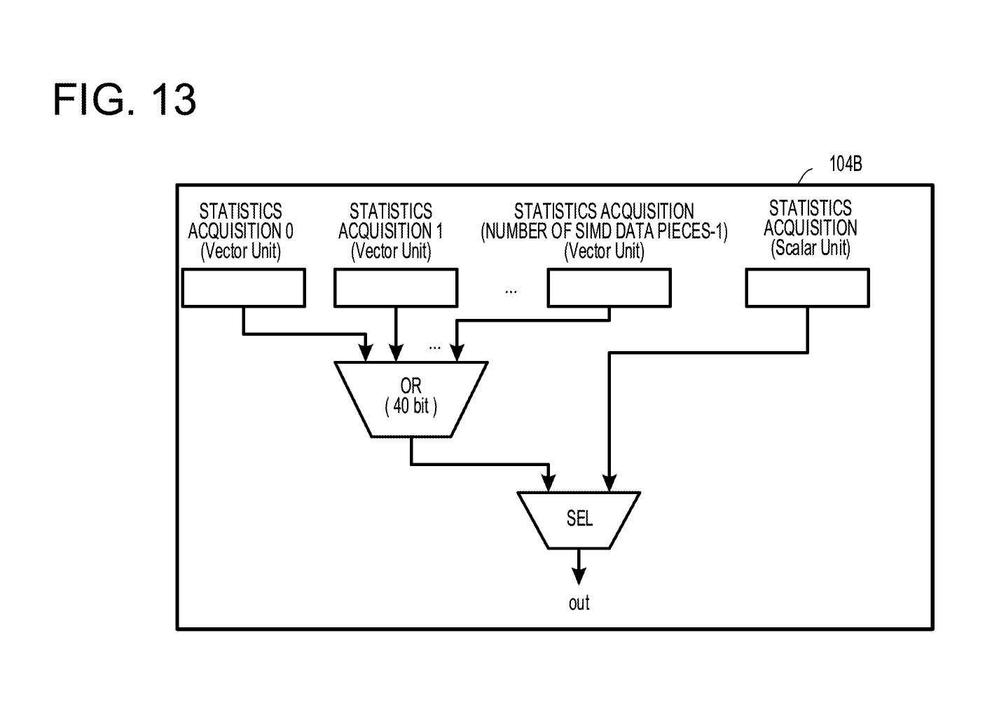

FIG. 13 illustrates a configuration of a hardware circuit of the statistical information aggregating unit 104B that aggregates bit positions by an OR operation as a precondition for acquiring a maximum value and a minimum value of bit positions from data acquired by the statistical information acquisition unit 102B. The data acquired by the statistical information acquisition unit 102B (here, from statistics acquisition, 0, to statistics acquisition, the number of SIMD data pieces-1) is ORed by an OR gate (40 bits). In FIG. 13, the selector SEL selects data acquired from an OR operation (OR) and the scalar unit 14. The data selected by the selector SEL is output to output data out. Therefore, data acquired by the statistical information acquisition unit 102B through the scalar unit 14 is output, as it is, to output data out without being ORed in the first time operation. Out is data to be delivered to the statistical information storage 105Z.

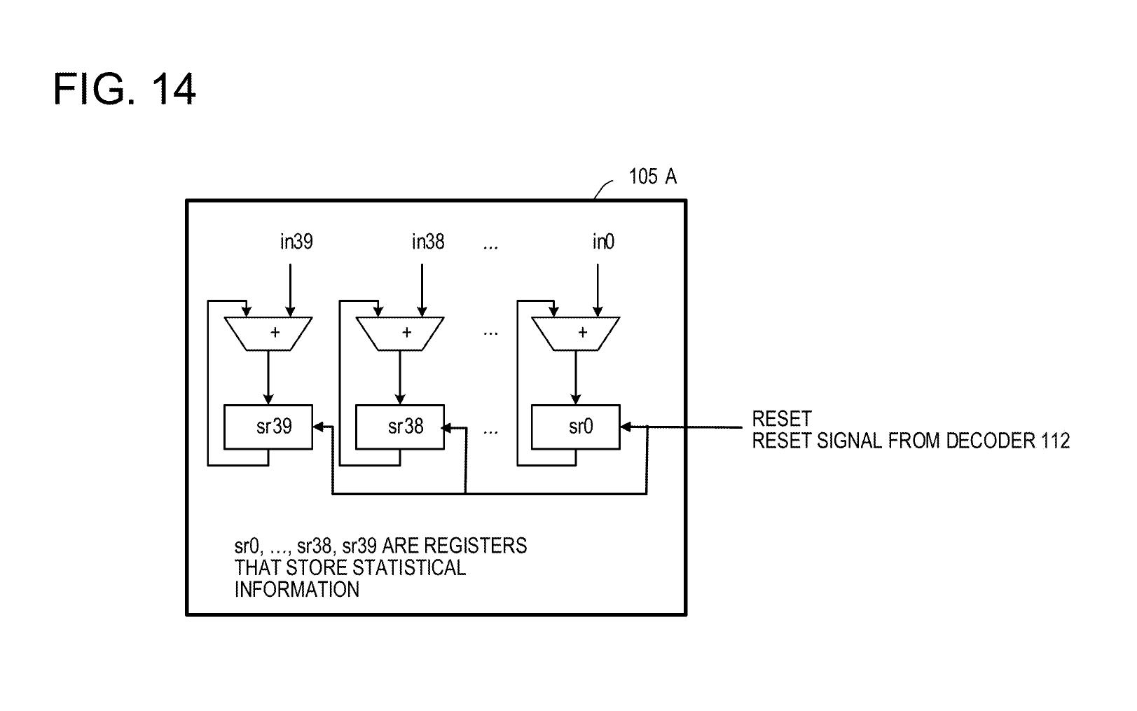

FIG. 14 illustrates a configuration of a statistical information storage 105A that stores statistical information from the statistical information aggregating unit 104A in a dedicated register, as a specific example of the statistical information storage 105Z (see FIG. 4). In the drawing, in39 to in0 indicate, for example, statistical information from the statistical information aggregating unit 104A, which corresponds to out39 to out0 in FIG. 11. sr39 to sr0 are registers that store statistical information. The processor 10Z writes initial values v39 to v0 in one or more of the registers sr39 to sr0, via a selector SEL (not illustrated) by a write command. Meanwhile, the processor 10Z may reset the registers sr39 to sr0 by a reset signal from a decoder. The processor 10Z accumulates statistical information by using an adder for each execution of an instruction with a statistical information acquisition function, and stores the statistical information in the registers sr39 to sr0. The processor 10Z reads one or more values from the registers (sr39 to sr0), and saves the value in a data memory specified by a read command, or stores the value in a general-purpose register specified by a read command.

Through the above configuration, the information processing apparatus of Comparative Example accumulates statistical information of each variable of each layer, in a register or a register file, for example, at the time of mini batch execution of deep learning. Then, the information processing apparatus in Comparative Example may update a decimal point position of each variable of each layer based on the accumulated statistical information. That is, the processor 10Z acquires statistical information of a bit distribution. Here, the statistical information includes, at the time of command execution, for example, (1) a distribution of unsigned most significant bit positions, (2) a distribution of unsigned least significant bit positions, (3) a maximum value of unsigned most significant bit positions, (4) a minimum value of unsigned least significant bit positions, or a combination thereof. Accordingly, when the information processing apparatus in Comparative Example executes deep learning, it is possible to implement a dynamic fixed-point operation in a practical time without overhead during the deep learning program for acquiring statistical information of data.

That is, the processor 10Z of the information processing apparatus of Comparative Example executes an instruction with a statistical information acquisition function, and executes an instruction to perform bit-shifting and rounding/saturation on an operation result and to store the result in a register. Accordingly, the information processing apparatus of Comparative Example may reduce the overhead for acquiring statistical information indicating a bit distribution. Further, it is possible to immediately determine a proper bit shift, that is, a decimal point position from the statistical information indicating a bit distribution.

However, in Comparative Example, the processor 10Z separately counts the statistical information at positions of all the bits (e.g., 40 bits) in the intermediate state of an operation. Accordingly, as illustrated in FIG. 4, registers and wirings within the circuit, from the statistical information acquisition unit 102Z to the statistical information aggregating unit 104Z, and from the statistical information aggregating unit 104Z to the statistical information storage 105Z, have a capacity corresponding to all the bits (e.g., 40 bits) in the intermediate state. This increases a circuit area and a power consumption.

[Statistical Information of Embodiment]

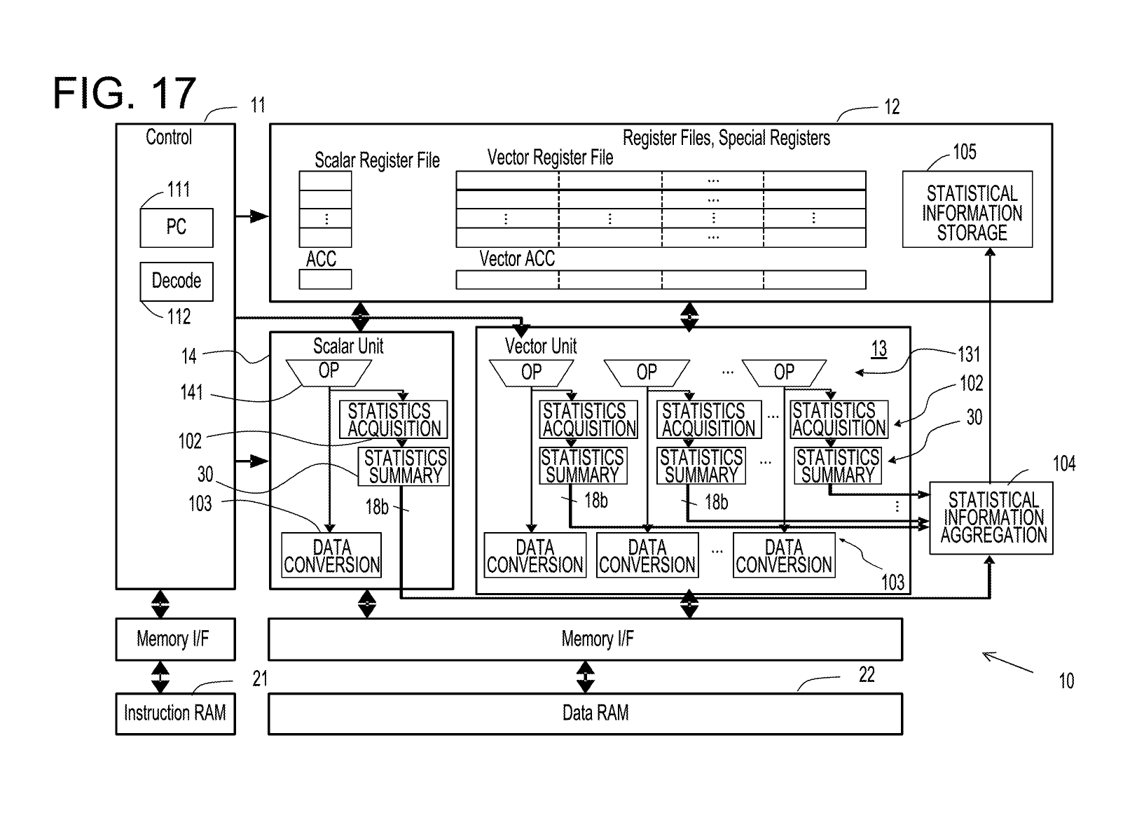

Hereinafter, a processor 10 of an information processing apparatus according to a first embodiment will be described (see FIG. 17). The processor 10 is an example of an arithmetic processing device according to the embodiment or a computer to execute an arithmetic processing method. In the first embodiment, the processor 10 processes statistical information of all the bits (e.g., 40 bits) in an intermediate state of an operation, in four separate bit areas. Here, the intermediate state of an operation refers to a state during which input data is taken from a register outside each arithmetic unit to the arithmetic unit, and then, an operation result is output to the register outside the arithmetic unit. In the intermediate state of the operation, a bit string as an operation target is kept within the arithmetic unit. Here, the arithmetic unit is, for example, a vector operation arithmetic unit 131 or a scalar operation arithmetic unit 141 in FIG. 17. Then, the processor 10 reduces a bit width of two areas with a low importance among four bit areas.

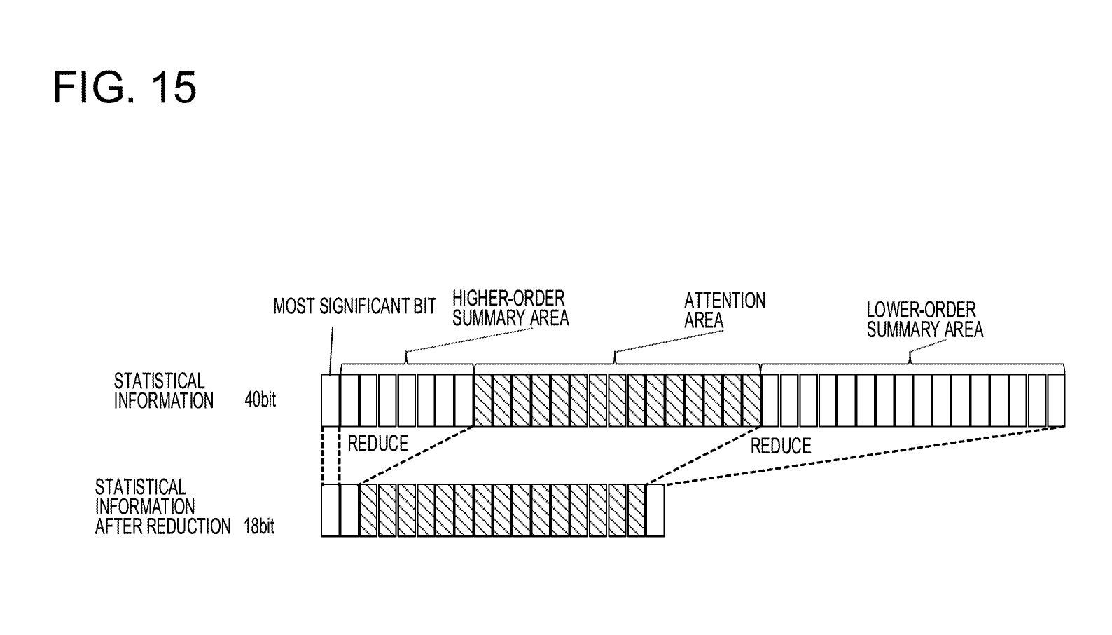

FIG. 15 illustrates statistical information including four bit areas. The four bit areas of the statistical information include the most significant bit, a higher-order side summary area, an attention area, and a lower-order side summary area. Among them, each of the higher-order side summary area and the lower-order side summary area is reduced to one bit. As a result, the number of bits of the reduced statistical information corresponds to the most significant bit (one bit)+the higher-order side summary area (one bit)+the attention area (N bits)+the lower-order side summary area (one bit). When the number of bits of the attention area is, for example, 15 bits (N=8), the number of bits of the reduced statistical information is 18 bits in total.

Here, the attention area is an area designated, for example, for the processor 10 from an application program by a user. Meanwhile, the attention area may be an area designated by the processor 10 by the processing of the application program. As the attention area, for example, higher and lower (2N−1) bits centered on a high frequency position, as the most significant bit position, in an numerical area (e.g., an area of single-precision 16 bits) that is expressible at the current accuracy may be designated. As the attention area, for example, higher and lower (2N−1) bits centered on a high frequency position, as the least significant bit position, in an area expressible at the current accuracy, may be designated. The attention area of (2N−1) bits will be referred to as a window. When the size of the attention area is set as (2N−1) bits, N is called a window size parameter.

In the present embodiment, the processor 10 extracts information in a 1-bit-to-1-bit correspondence within a window. Meanwhile, the processor 10 detects the presence or absence of a flag at the higher-order bit side (one bit) and the lower-order bit side (one bit), outside the window. Here, as described above, the flag indicates bit 1 indicating (1) an unsigned most significant bit position, (2) an unsigned least significant bit position, (3) a position of a maximum value of unsigned most significant bit positions, or (4) a position of a minimum value of unsigned least significant bit positions, in the statistical information.

The most significant bit in the statistical information is a bit which becomes 1 in a special case where there is no value different from a sign bit in input data as a statistical information acquisition target. The most significant bit in the statistical information stores a sign bit when there is a value different from a sign bit in input data as a statistical information acquisition target. That is, the most significant bit in the statistical information does not have a relationship such as a higher order or a lower order with respect to the attention area. Thus, the processor 10 extracts a sign bit in the input data as the statistical information acquisition target, as it is, and sets the sign bit as the most significant bit of the statistical information. In a special case where there is no value different from a sign bit in the input data as the statistical information acquisition target, the processor 10 sets 1 to the most significant bit of the statistical information.

[Instruction Format]

Hereinafter, descriptions will be made on an instruction format of an instruction to specify a user-specified bit position at the time of statistical information acquisition according to the present embodiment.

[First Instruction Format]

In an instruction format example 1, a function of designating a user-specified bit position is individually added to, for example, an operation instruction and a load instruction in which statistical information is acquired.

[Instruction Format Example 1.1]

For the command of vmul_su vs, vt, vd, imm, usr, vector registers vs and vt are multiplied, an imm bit shift is performed, rounding and saturation are performed, and the result is stored in a register vd outside the arithmetic unit. Statistical information in which the multiplication result is not yet shifted is acquired, and accumulated in the statistical information register. When the statistical information is acquired, (2N−1) centered on a usr bit are set as the attention area.

[Instruction Format Example 1.2]

For the command of vld_su rs, rt, rd, usr, vector data is loaded from an address obtained by adding address registers rs to rt, and is stored in a vector register rd. Statistical information of the loaded data is acquired and accumulated in the statistical information register. When the statistical information is acquired, (2N−1) centered on a usr bit are set as the attention area.

[Instruction Format Example 1.3]

For the command of read_acc_su rd, imm, usr, with respect to data of an accumulator⋅register (40 bits), an imm bit shift is performed, and rounding and saturation are performed, and the result is stored in a scalar register rd. The processor 10 acquires statistical information from data of the accumulator register, and accumulates the statistical information in the statistical information register. When the statistical information is acquired, (2N−1) centered on a usr bit are set as the attention area.

The attention area may not be the area of (2N−1) bits centered on the usr bit as long as the attention area is determined by the usr bit. For example, the processor 10 may set, for example, higher-order (2N−1) bits with respect to the usr bit, or lower-order (2N−1) bits with respect to the usr bit, as the attention area.

[Second Instruction Format]

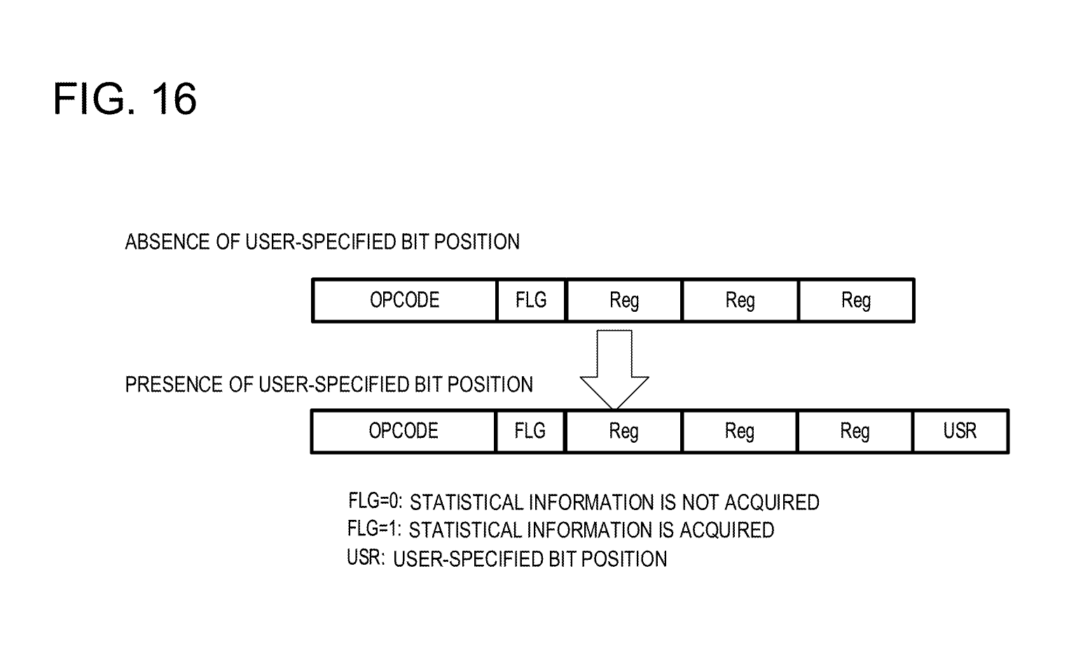

FIG. 16 illustrates a second instruction format. The second instruction format corresponds to an extension of a configuration of a conventional instruction format, in which an area in which a user-specified bit position is designated is added. In FIG. 16, in the instruction format OPCODE, FLG, Reg, Reg, Reg, and USR, a user-specified bit position USR is designated, unlike in the conventional instruction format OPCODE, FLG, Reg, Reg, and Reg. Here, FLG=0 specifies that statistical information is not acquired, and FLG=1 specifies that statistical information is acquired. OPECODE is a general instruction to perform an operation, for example, LOAD, ADD, SUB, or STORE. The statistical information is accumulated in the statistical information register.

[Third Instruction Format]

An instruction to specify an independent user-specified bit position is added.

[Instruction Format Example 3.1] set_usr usr

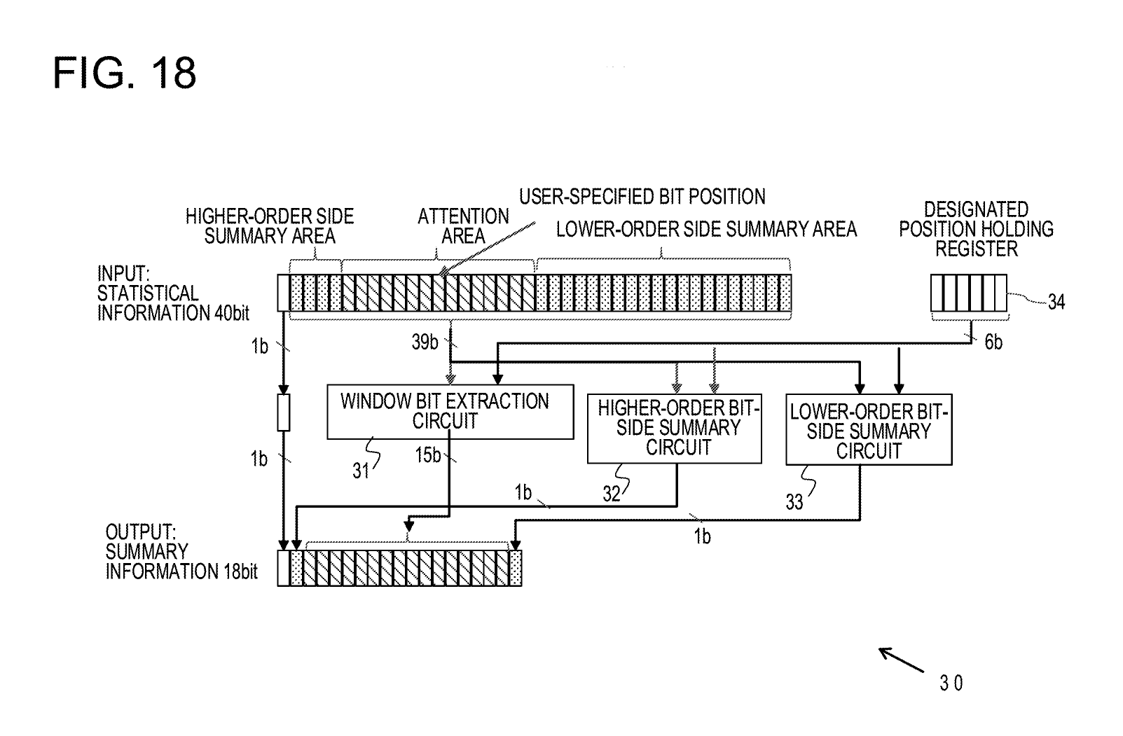

The processor 10 stores a value usr (user-specified bit position information) in a designated position holding register 34 (see FIG. 18) that holds a user-specified bit position. The user program sets the user-specified bit position information in the designated position holding register 34 by using the set_usr instruction prior to an instruction with a statistical information acquisition function.

By implementing an instruction in the instruction format as described above, the processor 10 accepts designation of a user-specified bit position from an application program. Then, by the processor 10, statistical information after the execution of an operation may be acquired, summarized, and aggregated, and then, accumulated in the statistical information register. Then, for example, by a statistical information register read command, the processor 10 may deliver the statistical information to the application program.

[Circuit Configuration]

FIG. 17 illustrates a circuit block of the processor 10 in the present embodiment. Similarly to the processor 10Z in Comparative Example, the processor 10 includes a control unit 11, a register file 12, a vector unit 13, a scalar unit 14, and a statistical information aggregating unit 104. The control unit 11 includes a program counter 111 and a decoder 112. The register file includes a vector register file, an accumulator register (Vector ACC) for a vector operation, a scalar register file, and an accumulator register (ACC) for a scalar operation. The vector unit 13 includes the vector operation arithmetic unit 131, a statistical information acquisition unit 102, and a data converter 103. The scalar unit 14 includes the scalar operation arithmetic unit 141, the statistical information acquisition unit 102, and the data converter 103. A statistical information storage 105 is set as a part of the register file 12. The configuration of the processor 10 in FIG. 17 is the same as that of the processor 10Z in FIG. 7, except that a statistical information summarizing unit 30 is provided at the subsequent stage of the statistical information acquisition unit 102. The statistical information summarizing unit 30 reduces statistical information at all the bits (e.g., 40 bits) in the intermediate state, into, for example, the most significant bit (one bit)+a higher-order side summary area (one bit)+an attention area (N bits)+a lower-order side summary area (one bit) as illustrated in FIG. 15, and then delivers the reduced statistical information to the statistical information aggregating unit 104. The vector operation arithmetic unit 131 is an example of an arithmetic unit that outputs operation result data obtained by calculating operation target data. The scalar operation arithmetic unit 141 is also an example of the above arithmetic unit. The vector operation arithmetic unit 131, or a combination of the vector operation arithmetic unit 131 and the scalar operation arithmetic unit 141 is an example of a plurality of arithmetic units.

The configuration and the operation of the statistical information acquisition unit 102 are the same as those of the statistical information acquisition unit 102Z (102A and 102B) in the Comparative Example, and thus, descriptions thereof will be omitted. The statistical information acquisition unit 102 is an example of a generator that outputs statistical information data indicating a bit distribution in operation result data. Similarly to the statistical information acquisition unit 102Z in Comparative Example as illustrated in FIG. 6, the statistical information acquisition unit 102, as the generator, generates statistical information data in which any one of bits is 1, with respect to the operation result from the vector operation arithmetic unit 131 or the scalar operation arithmetic unit 141.

The configuration and the operation of the statistical information aggregating unit 104 are the same as those of the statistical information aggregating unit 104Z (104A and 104B) in Comparative Example, and thus, descriptions thereof will be omitted. The statistical information aggregating unit 104 is an example of a statistical information aggregating unit that outputs statistical information aggregated data obtained by aggregating summary data output by a plurality of above arithmetic units.

The configuration and the operation of the statistical information storage 105 are the same as those of the statistical information storage 105Z (105A) in Comparative Example, and thus, descriptions thereof will be omitted. The statistical information storage 105 is an example of a statistical information storage that stores the statistical information aggregated data.

[Statistical Information Summarizing Unit]

FIG. 18 illustrates a configuration of the statistical information summarizing unit 30. FIG. 18 also illustrates the designated position holding register 34 that holds information on the center position of a window specified by the user. As described above, the statistical information summarizing unit 30 reduces the number of bits from statistical information with all the bits (e.g., 40 bits) in an intermediate state prior to a reduction of the number of bits, and outputs summarized statistical information (hereinafter, also referred to as summary information).

As illustrated in FIG. 18, the statistical information summarizing unit 30 includes a window bit extraction circuit 31, a higher-order bit-side summary circuit 32, and a lower-order bit-side summary circuit 33. In this configuration, the most significant bit is output, as it is, as the summary information. The higher-order bit-side summary circuit 32 summarizes a bit string in the higher-order side summary area into one bit, and extracts and outputs the bit as the summary information. The window bit extraction circuit 31 extracts the attention area, as it is, as a window, and outputs the attention area as the summary information. The lower-order bit-side summary circuit 33 summarizes a bit string in the lower-order side summary area into one bit, and extracts and outputs the bit as the summary information. The designated position holding register 34 provides a user-specified bit position to each of the window bit extraction circuit 31, the higher-order bit-side summary circuit 32, and the lower-order bit-side summary circuit 33. That is, the statistical information summarizing unit 30 is an example of a circuit that outputs summary data including the most significant bit, the higher-order side summary data, the attention area data, and the lower-order side summary data in statistical information data.

[Window Bit Extraction Circuit 31]

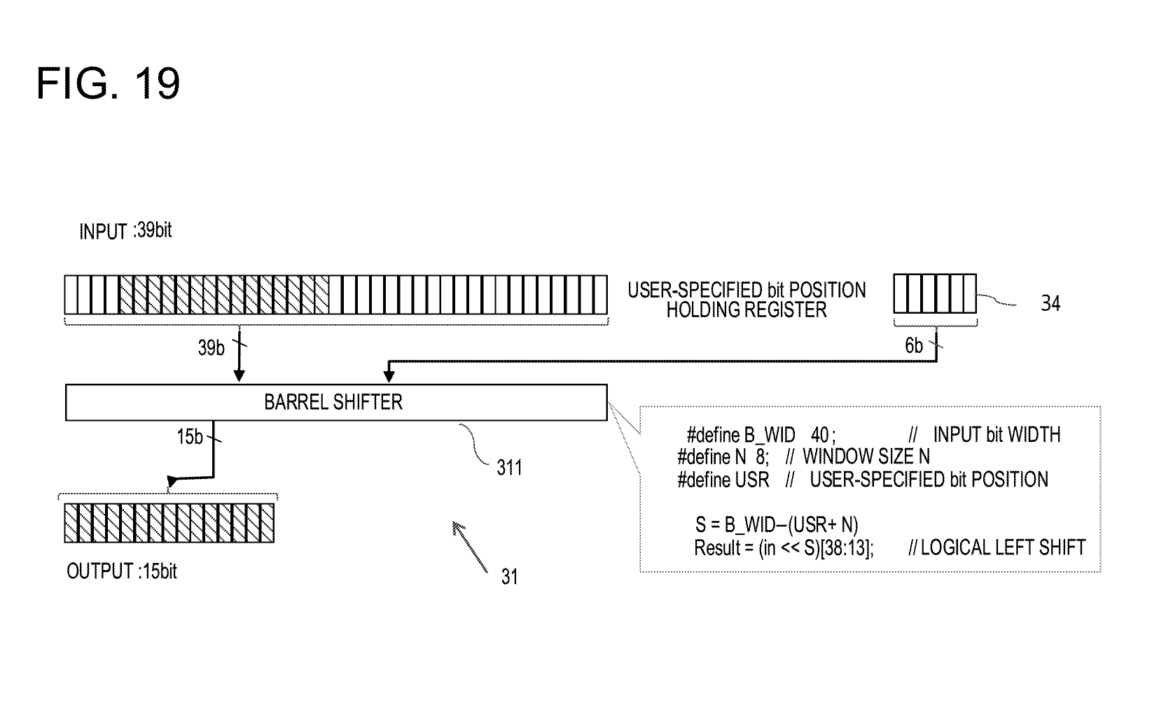

FIG. 19 illustrates a configuration of the window bit extraction circuit 31. FIG. 19 also illustrates the designated position holding register 34. The window bit extraction circuit 31 includes a barrel shifter 311. The window bit extraction circuit 31 performs a logical left shift on bits excluding a sign bit (e.g., 39 bits) by a predetermined bit (S bits), and acquires higher-order bits corresponding to a size of a window. Here, the predetermined bit S is calculated by the number of input bits (B_WID)−(window size parameter N+user-specified position USR). Here, the number of input bits (B_WID) is the number of input bits including the sign bit as the most significant bit. The window size parameter N is a parameter N that designates a window size 2N−1. The USR is a number of a bit position, in which the least significant bit is 1. The user-specified position USR is an example of specified position information. The window size 2N−1 is an example of a first predetermined size. The barrel shifter 311 is an example of a shift circuit that shifts attention area data with the window size (2N−1) as the first predetermined size, to the left, based on the specified position information (the user-specified position USR), and extracts the attention area data.

For example, assuming that N=8, and USR=31 when the window size is 15, the predetermined bit S=40-8−31=1, and then, the barrel shifter 311 performs a logical left shift on input 39 bits excluding a sign bit, by one bit. Then, the window bit extraction circuit 31 may extract higher-order 15 bits (=2N−1) from the shifted data. Through this configuration, the attention area with higher 7 (=N−1) bits and lower 7 bits centered on the USR=31, that is, 15 bits in total, is acquired. Meanwhile, in the present embodiment, the window size parameter N is not limited to 8. When the USR is designated by a bit number starting from bit 0, 39 bits not including a sign bit may be set as the number of input bits (B_WID). The predetermined bit S is calculated as S=number of input bits(39)−(window size parameter N+user-specified position USR). The window bit extraction circuit 31 is an example of an extractor that extracts attention area data with a first predetermined size based on specified position information.

[Higher-Order Bit-Side Summary Circuit 32]

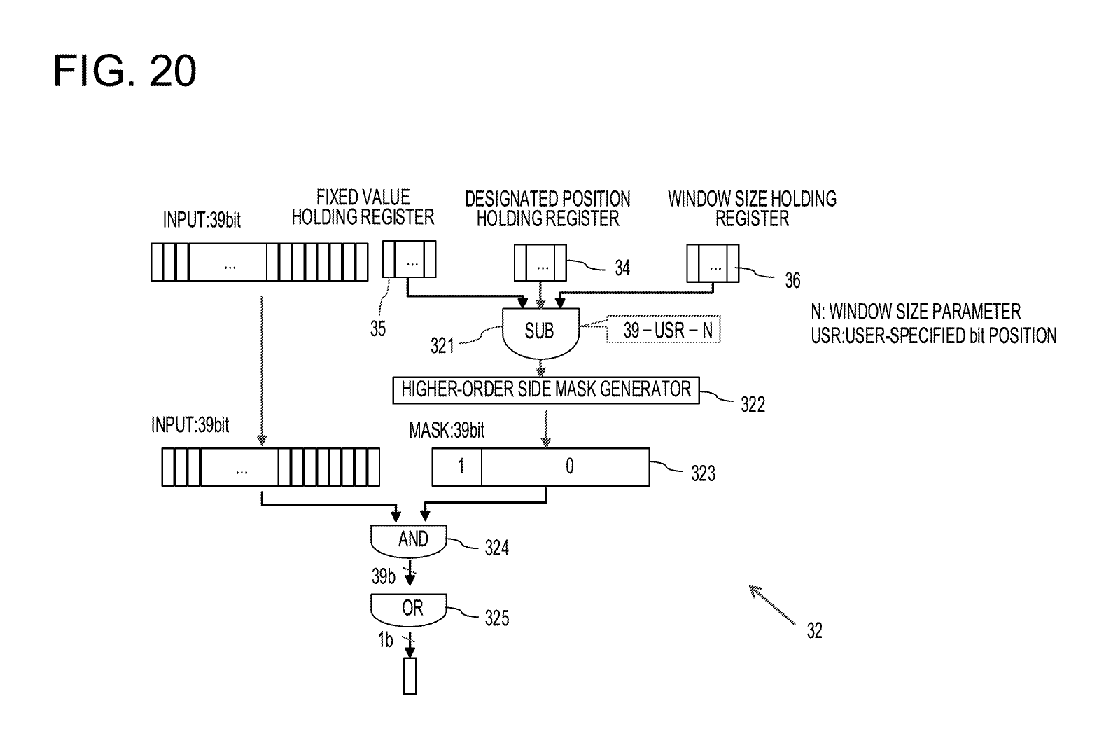

FIG. 20 illustrates a configuration of the higher-order bit-side summary circuit 32. FIG. 20 illustrates the designated position holding register 34, a fixed value holding register 35, and a window size holding register 36, in addition to the higher-order bit-side summary circuit 32. Here, the fixed value holding register 35 holds the number of bits (e.g., 40) in an intermediate state prior to reduction of the number of bits. The window size holding register 36 holds the window size parameter N (e.g., 8). As described above, the designated position holding register 34 holds a value of the user-specified position USR.

As illustrated in FIG. 20, the higher-order bit-side summary circuit 32 includes a Subtract (SUB) circuit 321, a higher-order side mask bit generator 322, a higher-order side mask register 323, an AND circuit 324, and an OR circuit 325. The SUB circuit 321 generates a bit width of a higher-order side summary area, from the number of bits (a fixed value 40) in the intermediate state, the user-specified position (USR), and the window size parameter N. For example, when the user-specified position USR=29, and the window size parameter N=8, the higher 7 bits and lower 7 bits centered on the bit position 29, that is, 15 bits in total (from 36th bit to 22nd bit), correspond to the attention area. Therefore, the higher-order side summary area corresponds to 3 bits from 37th bit to 39th bit. Then, the SUB circuit 321 outputs 40-USR-N=3 to the higher-order side mask bit generator 322. Meanwhile, as described above, when the USR is designated by a bit number starting from bit 0, 39 bits not including a sign bit may be designated set as the number of input bits (B_WID).

The higher-order side mask bit generator 322, to which the bit width is input from the SUB circuit 321, generates a higher-order side mask pattern in which 1 is set to higher-order bits for the input bit width. For example, when the SUB circuit 321 outputs a bit width of 3, the higher-order side mask bit generator 322 generates a higher-order side mask pattern in which three higher-order bits are 1 and other bits are 0, and outputs the higher-order side mask pattern to the higher-order side mask register 323.

The AND circuit 324 executes an AND operation of a bit string of input data and a bit string of the higher-order side mask register 323. The OR circuit 325 executes an OR operation between bits of a bit string which is a result of the AND operation between the bit string of the input data and the bit string of the higher-order side mask register 323. Accordingly, when bit 1 is included in a portion in the input data masked by the AND circuit 324 and the higher-order side mask register 323, the output of the OR circuit 325 becomes 1. Meanwhile, when bit 1 is not included in a portion in the input data masked by the AND circuit 324 and the higher-order side mask register 323, but all bits are 0, the output of the OR circuit 325 becomes 0.

That is, the higher-order bit-side summary circuit 32 extracts the bit string of the higher-order side summary area in the input data, through the mask pattern of the higher-order side mask register 323, summarizes the bit string into one bit by executing an OR operation between bits in the higher-order side summary area, and extracts the bit. That is, when at least one of 1 bit is included in all bits in the higher-order side summary area, the summarized value becomes 1. Meanwhile, when all the bits in the higher-order side summary area are 0, the summarized value becomes 0. The higher-order bit-side summary circuit 32 is an example of a higher-order side summarizing unit that outputs higher-order side summary data, which is obtained by summarizing higher-order side data, in data other than attention area data, into a second predetermined size. One bit is an example of the second predetermined size, by which the higher-order side summary area is summarized by the higher-order bit-side summary circuit 32. The AND circuit 324 is an example of a circuit that executes an AND operation between higher-order side summary area data as a summarizing target, in statistical information data, and higher-order side mask data generated based on specified position information. The OR circuit 325 is an example of a circuit that executes an OR operation between all the bits of first AND result data which is a result of the AND operation.

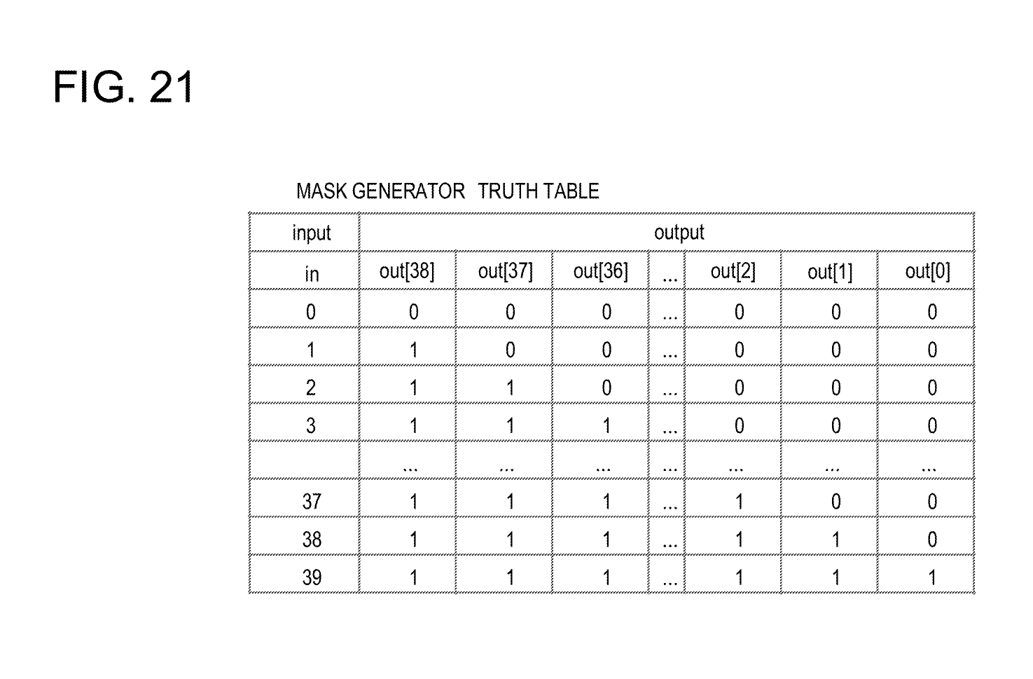

FIG. 21 illustrates a truth table of the higher-order side mask bit generator 322. In the drawing, “input” indicates an input bit string, “output” indicates an output bit string, “in” indicates variables (in[0] to in[39]) storing an input bit string, and “out[38] to out[0]” indicate variables storing an output bit string. As illustrated in FIG. 21, the higher-order side mask bit generator 322 sets 1 to bits in order from a higher-order bit with a bit width corresponding to an input value (input). The higher-order side mask bit generator 322 sets 0 to bits at lower orders than the bit width corresponding to the input value. For example, when input=1, among the output bits out[39:0], the most significant bit out[39] is set as 1, and all the bits equal to or lower than out[38] are set as 0. For example, when input=2, among the output bits out[39:0], two bits from the most significant bit are set as 1 (out[39]=1 and out[38]=1), and all the bits equal to or lower than out[37] are set as 0. When input=k, among the output bits out[39:0], k bits from the most significant bit are set as 1 (out[39]=1, . . . , out[39-k+1]=1), and all the bits equal to or lower than out[39-k] are set as 0.

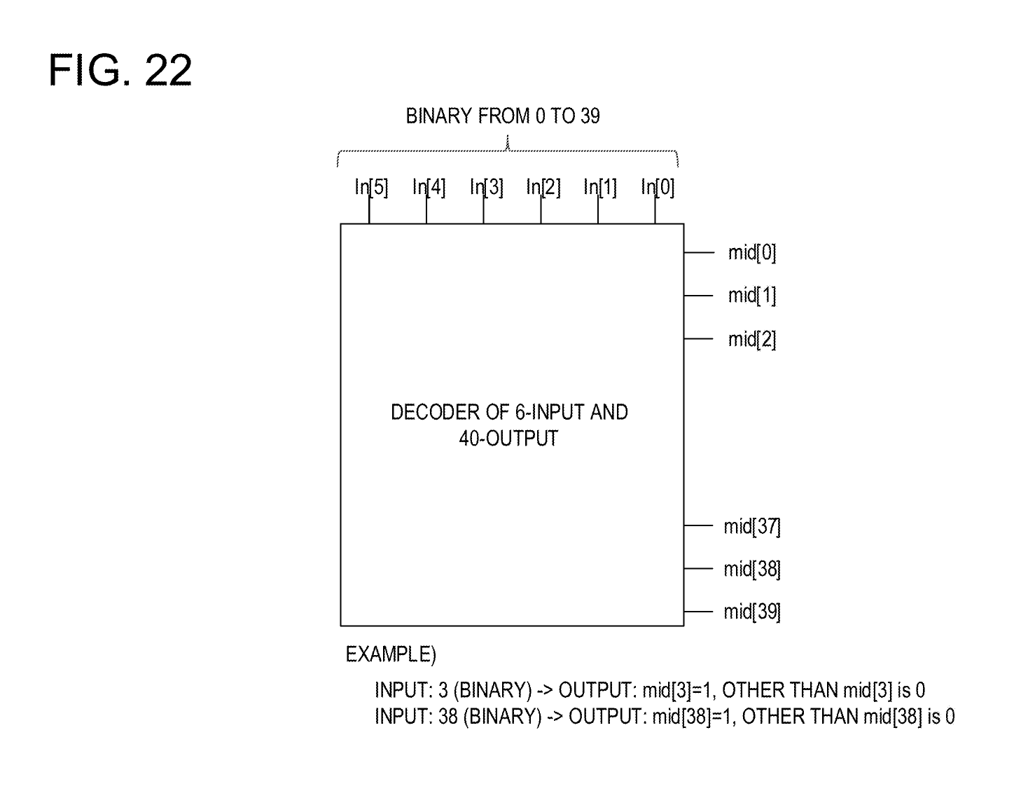

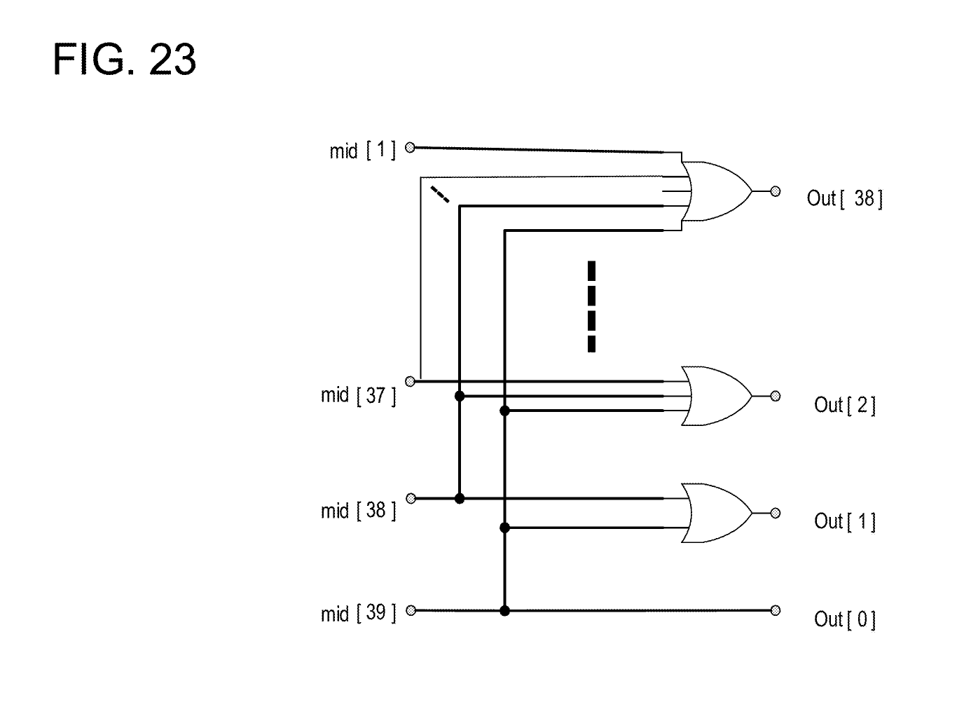

FIG. 22 is an example of a decoder with 6 inputs and 40 outputs, and FIG. 23 is an example of a mask pattern circuit that generates a higher-order side mask pattern based on the outputs (mid[1] to mid[39]) of the decoder in FIG. 22. In FIG. 22, only any one of the output bits mid[0] to mid[39] corresponding to numerical values (0 to 39) input to six bits from In[0] to In[5] is set to 1, and other bits are set to 0. For example, when a value of an input is 3, mid[3] becomes 1, and bits other than mid[3] become 0. For example, when a value of an input is 38, mid[38] becomes 1, and bits other than mid[38] become 0.

In the mask pattern circuit of FIG. 23, an input bit string is indicated by mid[1] to mid[39], and an output bit string is indicated by Out[0] to Out[38]. Then, in the mask pattern circuit of FIG. 23, mid[39] to mid[1] are associated with each of Out[0] to Out[38], and when mid[j]=1, Out[k] to out[38] corresponding to mid[j] become 1. For example, mid[39] is associated with Out[0], and when mid[39]=1, Out[0] to Out[38] are all 1. mid[38] is associated with Out[1], and when mid[38]=1, Out[0] is 0, and Out[1] to Out[38] become 1.

Accordingly, when mid[k] (k=1 to 39) in the decoder of FIG. 22 is input, as it is, to mid[k] (k=1 to 39) of the mask pattern circuit in FIG. 23, according to the 6-bit numerical value (k) by In[0] to In[5] to the decoder of FIG. 22, among 39 bits from Out[0] to Out[38] of FIG. 23, higher-order k bits may be set to 1, and other bits may be set to 0. Therefore, through a combination of the decoder in FIG. 22 and the mask pattern circuit in FIG. 23, the higher-order side mask bit generator 322 is formed.

[Lower-Order Bit-Side Summary Circuit 33]

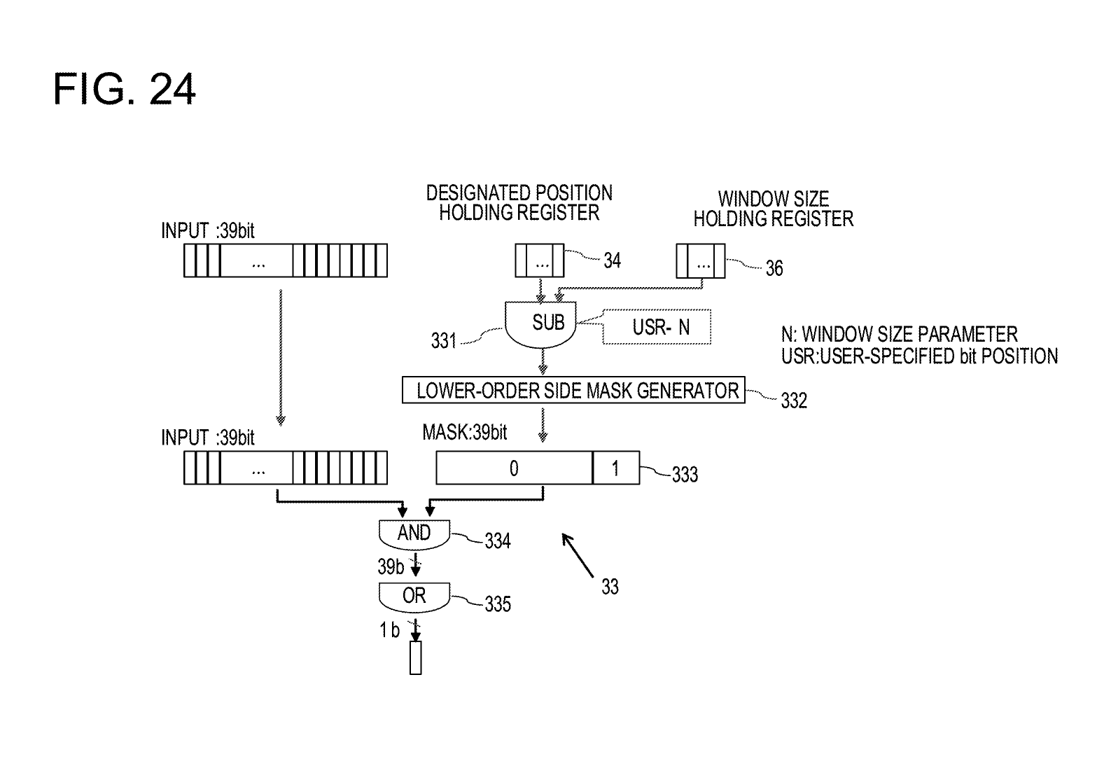

FIG. 24 illustrates a configuration of the lower-order bit-side summary circuit 33. FIG. 24 illustrates the designated position holding register 34, and the window size holding register 36, in addition to the lower-order bit-side summary circuit 33. As described above, the window size holding register 36 holds the window size parameter N (e.g., 8). As described above, the designated position holding register 34 holds a value of the user-specified position USR.

As illustrated in FIG. 24, the higher-order bit-side summary circuit 32 includes a SUB circuit 331, a lower-order side mask bit generator 332, a lower-order side mask register 333, an AND circuit 334, and an OR circuit 335. The SUB circuit 321 generates a bit width of a lower-order side summary area, from the user-specified position (USR) and the window size parameter N. For example, when the user-specified position USR=12, and the window size parameter N=8, the higher 7 bits and lower 7 bits centered on the bit position 12 (12th bit in order from a lower-order), that is, 15 bits in total (from 19th bit to 5th bit) correspond to the attention area. Therefore, the lower-order side summary area corresponds to 4 bits from 4th bit to 1st bit. Then, the SUB circuit 321 outputs S=USR-N=4, to the lower-order side mask bit generator 332. Here, the USR is a number of a bit position, in which the least significant bit is 1. When the USR is designated by a bit number starting from bit 0, S is calculated as S=USR-N+1.

The lower-order side mask bit generator 332, to which the bit width is input from the SUB circuit 331, generates a lower-order side mask pattern in which 1 is set to lower-order bits for the input bit width. For example, when the SUB circuit 331 outputs a bit width of 4, the lower-order side mask bit generator 332 generates a lower-order side mask pattern in which four lower-order bits are 1, and other bits are 0, and outputs the lower-order side mask pattern to the lower-order side mask register 333.

The AND circuit 334 executes an AND operation of a bit string of input data and a bit string of the lower-order side mask register 333. The OR circuit 335 executes an OR operation between bits of a bit string which is a result of the AND operation between the bit string of the input data and the bit string of the lower-order side mask register 333. Accordingly, when bit 1 is included in a portion in the input data masked by the AND circuit 334 and the lower-order side mask register 333, the output of the OR circuit 335 becomes 1. Meanwhile, when bit 1 is not included in a portion in the input data masked by the AND circuit 334 and the lower-order side mask register 333, but all bits are 0, the output of the OR circuit 335 becomes 0.

That is, the lower-order bit-side summary circuit 33 extracts the bit string of the lower-order side summary area in the input data, through the mask pattern of the lower-order side mask register 333, summarizes the bit string into one bit by executing an OR operation between bits in the lower-order side summary area, and extracts the bit. That is, when at least one of 1 bit is included in all bits in the lower-order side summary area, the summarized value becomes 1. Meanwhile, when all the bits in the lower-order side summary area are 0, the summarized value becomes 0. The lower-order bit-side summary circuit 33 is an example of a lower-order side summarizing unit that outputs lower-order side summary data which is obtained by summarizing lower-order side data, in data other than attention area data, into a third predetermined size. One bit is an example of the third predetermined size, by which the lower-order side summary area is summarized by the lower-order bit-side summary circuit 33. The AND circuit 334 is an example of a circuit that executes an AND operation between lower-order side summary area data as a summarizing target, in statistical information data, and lower-order side mask data generated based on specified position information. The OR circuit 335 is an example of a circuit that executes an OR operation between all the bits of second AND result data which is a result of the AND operation.

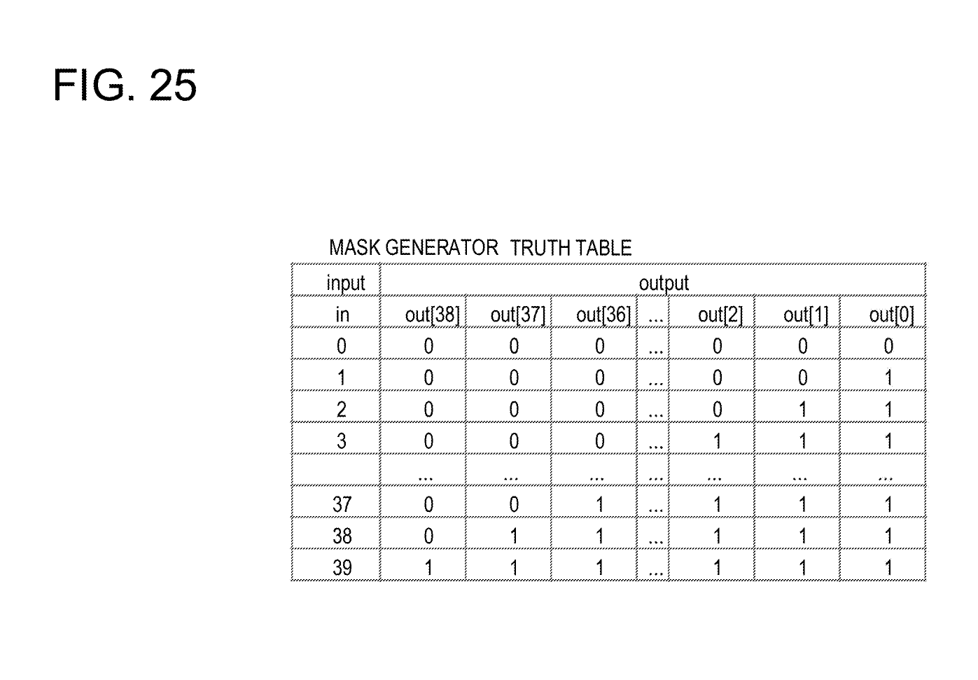

FIG. 25 illustrates a truth table of the lower-order side mask bit generator 332. As illustrated in FIG. 25, the lower-order side mask bit generator 332 sets 1 to bits in order from a lower-order bit with a bit width corresponding to an input value (input). The lower-order side mask bit generator 332 sets 0 to bits at higher orders than the bit width corresponding to the input value. For example, when input=1, among the output bits out[39:0], the least significant bit out[0] is set as 1, and all the bits equal to or higher than out[1] are set as 0. For example, when input=2, among the output bits output[39:0], two bits from the least significant bit are set as 1 (out[0]=1 and out[1]=1), and all the bits equal to or higher than out[3] are set as 0. When input=k, among the output bits output[39:0], k bits from the least significant bit are set as 1 (out[0]=1, . . . , out[k−1]=1), and all the bits equal to or higher than out[k] are set as 0.

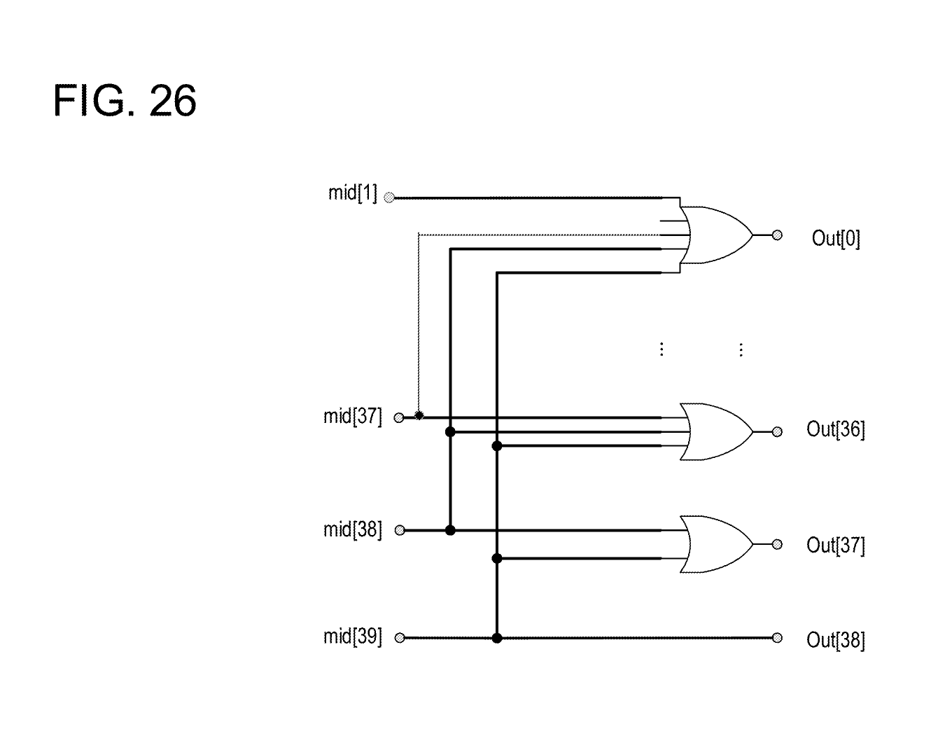

FIG. 26 is an example of a mask pattern circuit that generates a lower-order side mask pattern based on the outputs (mid[1] to mid[39]) of the decoder in FIG. 22. In the mask pattern generating circuit of FIG. 26, the arrangement order of the output bit string Out[0] to Out[38] is reversed as compared to that in the mask pattern generating circuit of FIG. 23. In FIG. 26 as well, an input bit string is indicated by mid[1] to mid[39], and an output bit string is indicated by Out[0] to Out[38].

That is, in the mask pattern circuit of FIG. 26, mid[39] to mid[1] are associated with each of Out[38] to Out[0], and when mid[j]=1, Out[j−1] to Out[0] corresponding to mid[j] become 1. For example, mid[39] is associated with Out[38], and when mid[39]=1, out[0] to out[38] are all 1. mid[38] is associated with Out[37], and when mid[38]=1, Out[0] to out[37] become 1, and Out[38]=0. For example, mid[1] is associated with Out[0], and when mid[1]=1, Out[0]=1, and Out[1] to Out[38] become 0.

Accordingly, when mid[k] (k=1 to 39) in the decoder of FIG. 22 is input, as it is, to mid[k] (k=1 to 39) of the mask pattern circuit in FIG. 26, according to the 6-bit numerical value (k) by In[0] to In[5] to the decoder of FIG. 22, among 39 bits from Out[0] to Out[38] of FIG. 26, lower-order k bits may be set to 1, and other bits may be set to 0. Therefore, through a combination of the decoder in FIG. 22 and the mask pattern circuit in FIG. 26, the lower-order side mask bit generator 332 is formed.

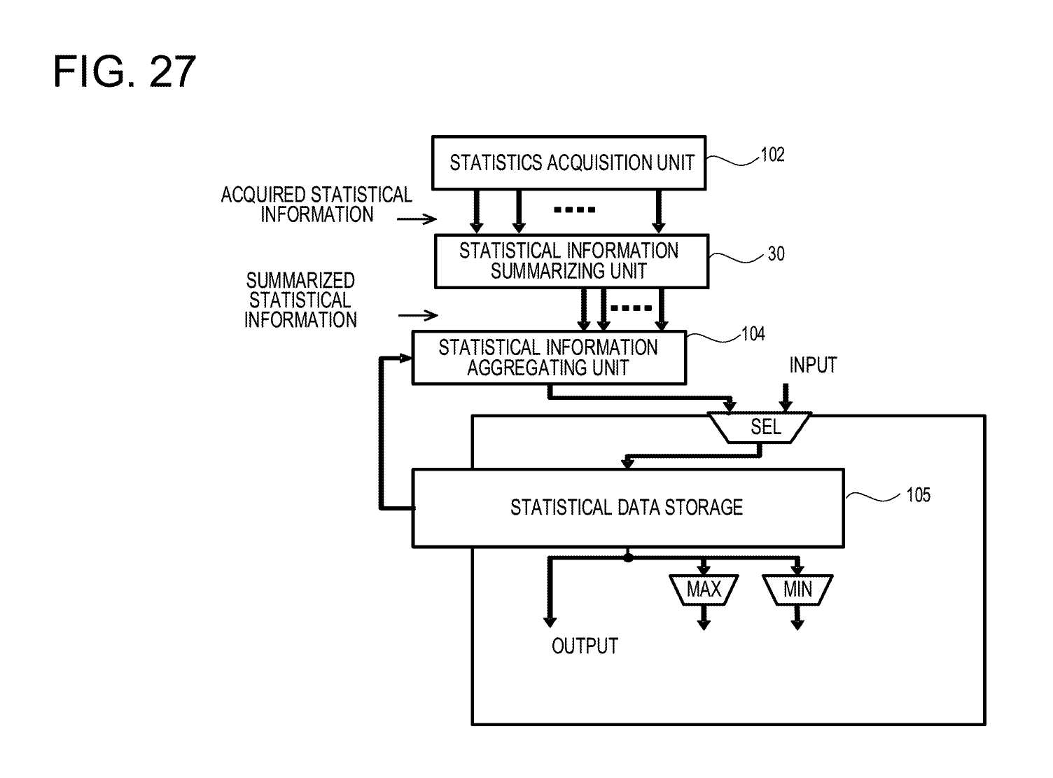

FIG. 27 illustrates a data flow between the statistical information acquisition unit 102, the statistical information summarizing unit 30, the statistical information aggregating unit 104, and the statistical information storage 105 in the first embodiment. Among them, details of the statistical information acquisition unit 102 are the same as those of the statistical information acquisition unit 102Z in Comparative Example. Details of the statistical information summarizing unit 30 are the same as those described above. The statistical information aggregating unit 104 and the statistical information storage 105 are the same as the statistical information aggregating unit 104Z and the statistical information storage 105Z in Comparative Example, except that statistical information is summarized, and the number of bits is reduced.

That is, in the present embodiment, the statistical information acquisition unit 102 generates statistical information with the number of bits (e.g., 40 bits) within an arithmetic circuit. Then, the statistical information summarizing unit 30 keeps the most significant bit (one bit) and the attention area (2N−1 bits, e.g., 15 bits) of the statistical information acquired by the statistical information acquisition unit 102, and summarizes each of the higher-order side summary area and the lower-order side summary area into one bit. Therefore, the statistical information (e.g., 40 bits) before summarized is summarized into, for example, 18-bit summary information, that is, summarized statistical information.

The statistical information aggregating unit 104 aggregates the summarized statistical information in the same procedure as that of Comparative Example. The statistical information storage 105 stores the summarized statistical information in the same procedure as that of Comparative Example. In FIG. 27, an input terminal to a selector SEL is a path through which a value of a memory or a general-purpose register is initially set in the statistical information storage 105. An output terminal from the statistical information storage 105 is a path through which data of the statistical information storage 105 is output to a memory or a general-purpose register.

An element that is regarded as MAX connected to the statistical information storage 105 is a circuit that selects the bit of a maximum value from a logical sum of accumulated unsigned most significant bit positions, in the statistical information stored in the statistical information storage 105, according to FIGS. 12 and 13 of Comparative Example. An element that is regarded as MIN connected to the statistical information storage 105 is a circuit that selects the bit of a minimum value from a logical sum of accumulated unsigned least significant bit positions, in the statistical information stored in the statistical information storage 105, according to FIGS. 12 and 13 of Comparative Example.

As clearly seen from FIG. 27, in the first embodiment, the statistical information summarizing unit 30 summarizes the statistical information and delivers the summarized statistical information to the statistical information aggregating unit 104. Therefore, in the processing subsequent to the statistical information aggregating unit 104, the statistical information has a summarized number of bits (e.g., 40 bits to 18 bits), and circuits and transmission paths are reduced in the scale by the number of the reduced bits.

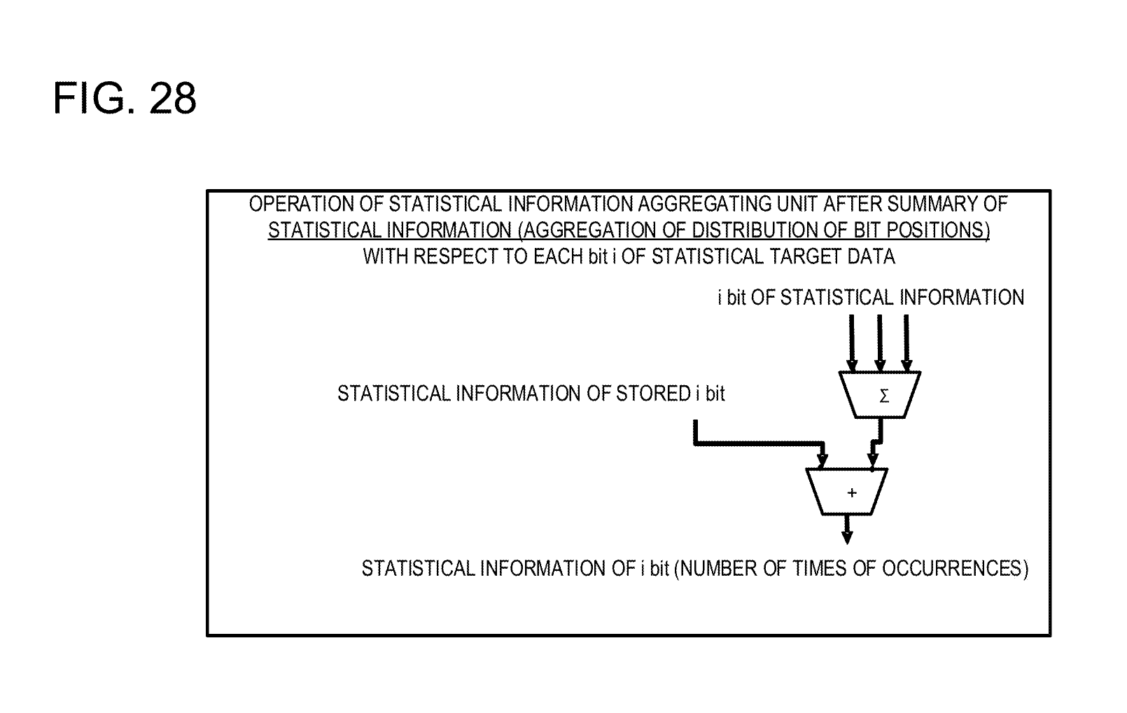

FIG. 28 is a view illustrating a configuration of the statistical information aggregating unit 104 that aggregates a distribution of unsigned most significant bit positions and a distribution of unsigned least significant bit positions. As in Comparative Example 1, the statistical information aggregating unit 104 adds each i bit of the statistical information by the number of vector data pieces, and integrates the bit with each i bit of the acquired statistical information. Meanwhile, in the first embodiment, since the statistical information is summarized by the statistical information summarizing unit 30, a configuration of arithmetic units (e.g., adders) included in the statistical information aggregating unit 104 is reduced by the number of reduced bits.

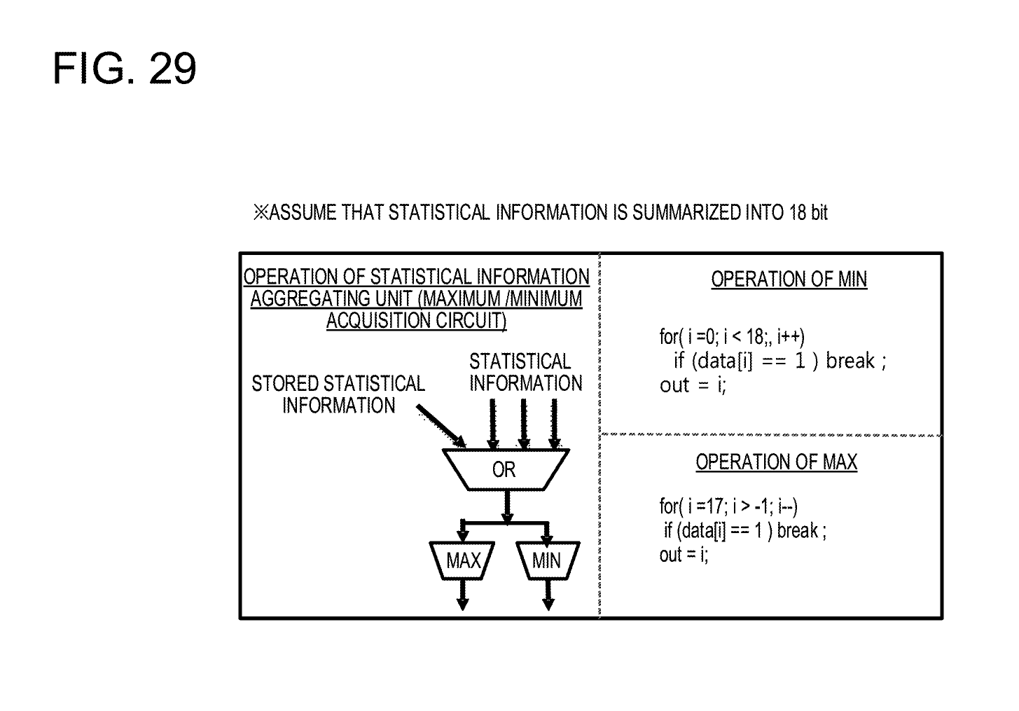

FIG. 29 is a view illustrating a configuration of the statistical information aggregating unit 104 that aggregates a maximum value of unsigned most significant bit positions and a minimum value of unsigned least significant bit positions. In FIG. 29, a processing of MAX and MIN is exemplified in pseudo code. In the drawing, an OR circuit is a circuit that performs OR operations on each column in an array in[j][i] of the statistical information as input data, with respect to all the rows (j=0, . . . , 7), as in FIG. 12 of Comparative Example. MAX and MIN are described in pseudo code, but are implemented by logic gates. Meanwhile, in the first embodiment, since the statistical information is summarized by the statistical information summarizing unit 30, circuits included in each configuration of FIG. 29 are reduced by the number of reduced bits.

### Effect of First Embodiment

As described above, in the first embodiment, the statistical information is summarized by the statistical information summarizing unit 30. As a result, subsequently to the statistical information summarizing unit 30, wirings are reduced by a reduction of a bit width of the statistical information aggregating unit 104 and the statistical information storage 105. For example, when the number of bits in the arithmetic circuit is 40 bits, and the summarized statistical information has 18 bits, it is expected that the number of gates and the number of wirings be almost halved.

The statistical information, as illustrated in FIG. 6, is data having a flag at one position. In order to improve the overflow occurrence rate and the underflow occurrence rate, it is desirable to collect a distribution of flags in the attention area, with a high accuracy. However, it is rare that a flag is set in the higher-order side summary area, and the lower-order side summary area. Accordingly, even when each of the higher-order side summary area, and the lower-order side summary area is aggregated into one bit, the statistical information itself is less deteriorated. Therefore, according to the configuration of the first embodiment, while the accuracy of the statistical information is maintained to some extent, it is possible to summarize the statistical information, thereby reducing a circuit scale, and then reducing a power consumption.

The statistical information acquisition unit 102 in the first embodiment generates statistical information in which any one of bits is 1, with respect to the operation result by the vector operation arithmetic unit 131, and the scalar operation arithmetic unit 141. Accordingly, the statistical information acquisition unit 102 may faithfully generate statistical information indicating (1) an unsigned most significant bit position, (2) an unsigned least significant bit position, (3) a position of a maximum value of unsigned most significant bit positions, and (4) a position of a minimum value of unsigned least significant bit positions. The statistical information may be summarized because any one of bits in the statistical information is 1, and low-frequency distributions are formed on both sides of the attention area as illustrated in FIG. 1.

Since data in the attention area is shifted to left by the barrel shifter 311 based on specified position information, and then extracted, the statistical information acquisition unit 102 may acquire the data in the attention area through a simple circuit configuration.

The higher-order bit-side summary circuit 32 executes an AND operation through the AND circuit 324 between a bit string of the higher-order side summary area as a summarizing target and a mask pattern of the higher-order side mask register 323 generated based on the user-specified position USR. Then, the higher-order bit-side summary circuit 32 performs an OR operation through the OR circuit 325, between all the bits of the first AND result data which is a result of the AND operation. Accordingly, the higher-order bit-side summary circuit 32 may simply summarize a bit string in the higher-order side summary area through two logic gates.

The lower-order bit-side summary circuit 33 executes an AND operation through the AND circuit 334 between a bit string of the lower-order side summary area as a summarizing target and a mask pattern of the lower-order side mask register 333 generated based on the user-specified position USR. Then, the lower-order bit-side summary circuit 33 performs an OR operation through the OR circuit 335, between all the bits of the second AND result data which is a result of the AND operation. Accordingly, the lower-order bit-side summary circuit 33 may simply summarize a bit string in the lower-order side summary area through two logic gates.

### Second Embodiment

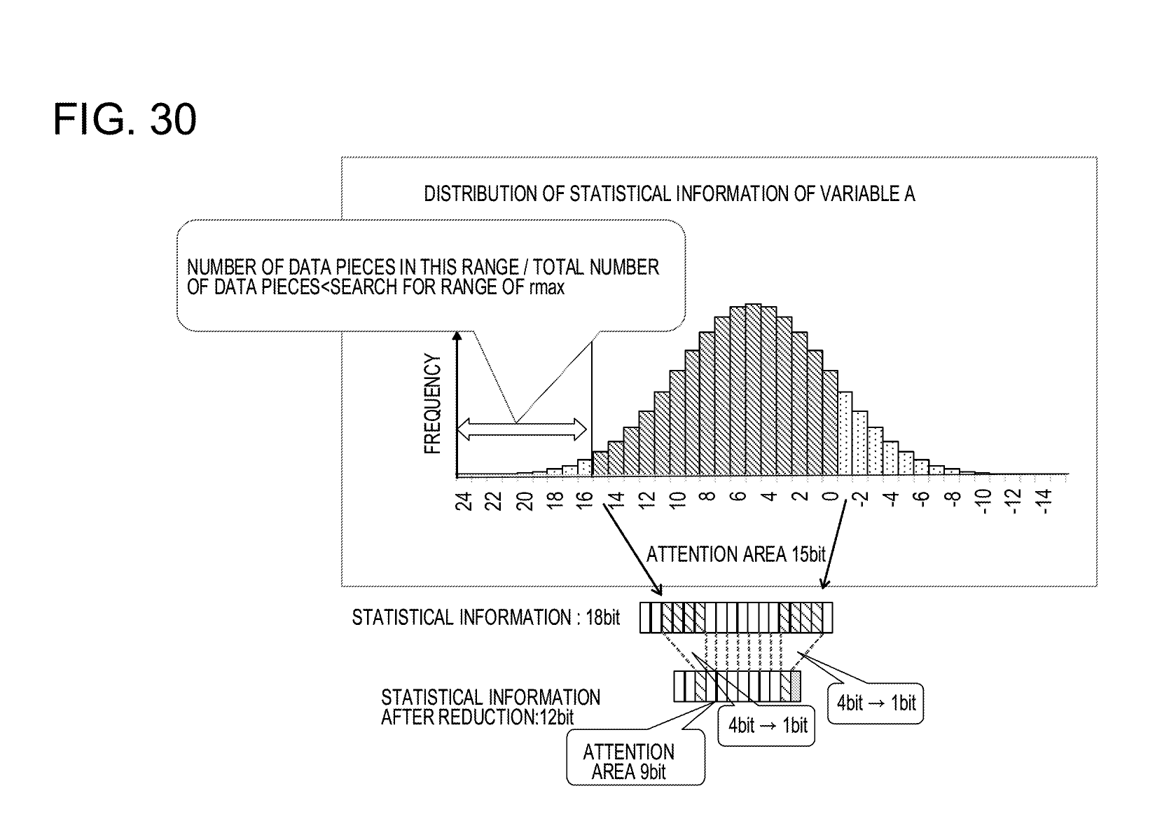

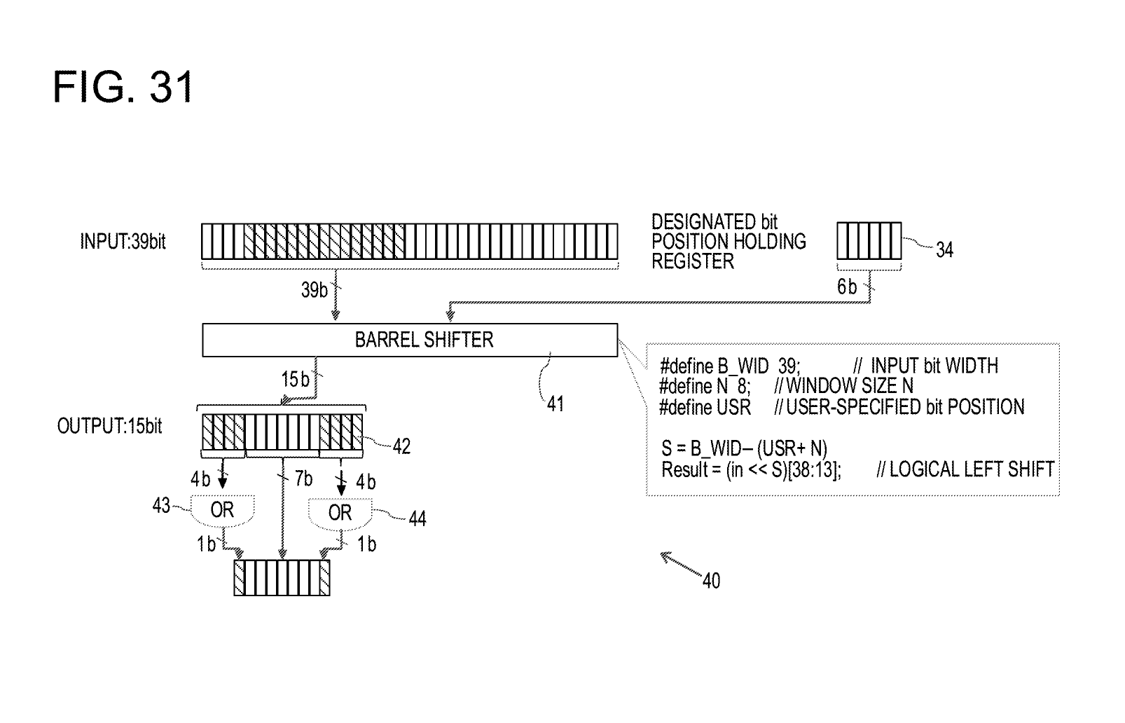

With reference to FIGS. 30 and 31, descriptions will be made on a processor 10 of an information processing apparatus according to a second embodiment. In the above first embodiment, the processor 10 divides the statistical information into the most significant bit, the higher-order side summary area, the attention area, and the lower-order side summary area. Then, the processor 10 summarizes each of the higher-order side summary area and the lower-order side summary area into one bit. In the present embodiment, the processor 10 further divides the attention area into a central portion and both-side peripheral portions. Then, the processor 10 summarizes each of the both-side peripheral portions in the attention area, into one bit. A circuit that summarizes the attention area, as described above, will be referred to as an attention area summarizing unit 40. A configuration of the processor 10, other than the attention area summarizing unit 40 summarizing the attention area, is the same as that in the first embodiment. Therefore, in the second embodiment, the configuration of the attention area summarizing unit 40 will be described assuming that the attention area summarizing unit 40 is added to the configuration of the first embodiment. The attention area summarizing unit 40 is incorporated in the statistical information summarizing unit 30 of FIG. 17 to process the attention area. The attention area summarizing unit 40 is an example of an attention area summarizing unit that summarizes a higher-order side portion of the attention area data, with a predetermined number of bits, into a fourth predetermined size, and summarizes a lower-order side portion of the attention area data, with a predetermined number of bits, into a fifth predetermined size.

FIG. 30 is a view illustrating a process in the second embodiment. In the drawing, an attention area of 15 bits is extracted from statistical information of 40 bits. A processing on a higher-order side summary area and a lower-order side summary area is the same as that of the first embodiment, and thus descriptions thereof will be omitted. Then, the processor 10 regards four bits on each of both sides of the attention area, as a peripheral portion. Then, the processor 10 summarizes each peripheral portion with four bits into one bit. A configuration of executing this summary is the same as the configuration of the statistical information summarizing unit 30 in the first embodiment. As a result, the attention area is reduced from, for example, 15 bits to 9 bits, and the statistical information as a whole is reduced to 12 bits.

FIG. 31 is a view illustrating a configuration of the attention area summarizing unit 40 that summarizes the attention area, in the second embodiment. As in the drawing, the attention area summarizing unit 40 includes a barrel shifter 41, a register 42 that holds data shifted by the barrel shifter, and OR circuits 43 and 44. A processing of the barrel shifter 41 is the same as that of the barrel shifter in the first embodiment, in which the statistical information is shifted by the following S. S=bit width (40) of statistical information-(user-specified bit position USR+window size parameter N)

The register 42 extracts higher-order 2N−1 bits, from the statistical information shifted by the barrel shifter 41. The OR circuits 43 and 44 perform an OR operation of four bits at each of the higher side and the lower side in the register 42, into one bit. When the higher-side four bits are ORed into one bit, the one bit is an example of the fourth predetermined size. When the lower-side four bits are ORed into one bit, the one bit is an example of the fifth predetermined size. Through such a configuration, the attention area of the statistical information is summarized from 15 bits to 9 bits. The number of bits to be summarized at both sides of the attention area is not limited to four bits. Through the above described configuration, the attention area may be reduced. Therefore, the processor 10 in the second embodiment may further reduce the statistical information as compared to that in the first embodiment.

For example, when the number of bits of the statistical information is reduced from 40 bits to 12 bits, it may be expected that wirings from the statistical information summarizing unit 30 including the attention area summarizing unit 40 to the statistical information storage 105 are reduced to 12/40=0.3 by 70%. One vector unit and one scalar unit are assumed for eight SIMD pieces. It is assumed that a flip-flop is a D-type flip-flop, and the number of gates is 10. On such assumption, when the number of bits of the statistical information is reduced from 40 bits to 12 bits, it is estimated that the total number of gates is reduced by about 64%.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An arithmetic processing device comprising:
a memory; and
a processor coupled to the memory and the processor configured to:
calculate input data of an operation target so as to obtain data of an operation result;
generate statistical information data for indicating a bit distribution in the data of the operation result;
extract attention area data with a first predetermined size from the statistical information data, based on specified position information;
generate higher-order side summary data obtained by summarizing higher-order side data of the statistical information data except the attention area data into a second predetermined size; and
generate lower-order side summary data obtained by summarizing lower-order side data of the statistical information data except the attention area data into a third predetermined size.

2. The arithmetic processing device according to claim 1,
wherein the processor generates the statistical information data in which any one of bits in the data of the operation result is 1.

3. The arithmetic processing device according to claim 1,
wherein the processor extracts the attention area data from the statistical information data by shifting the attention area data with the first predetermined size to left, based on the specified position information.

4. The arithmetic processing device according to claim 1,
wherein the processor executes an OR operation between all bits of first AND result data that is a result of executing an AND operation between higher-order side summary area data as a summarizing target and higher-order side mask data generated based on the specified position information.

5. The arithmetic processing device according to claim 1,
wherein the processor executes an OR operation between all bits of second AND result data that is a result of executing an AND operation between lower-order side summary area data as a summarizing target and lower-order side mask data generated based on the specified position information.

6. The arithmetic processing device according to claim 1,
wherein the processor generates summary data including a most significant bit in the statistical information data, the higher-order side summary data, the attention area data, and the lower-order side summary data.

7. The arithmetic processing device according to claim 6,
wherein the processor further generates statistical information aggregated data obtained by aggregating the summary data pluralized, and stores the statistical information aggregated data in the memory.

8. The arithmetic processing device according to claim 1,
wherein the processor further summarizes a higher-order side portion data of the attention area data, with a predetermined number of bits, into a fourth predetermined size, and summarizes a lower-order side portion data of the attention area data, with a predetermined number of bits, into a fifth predetermined size.

9. An arithmetic processing method comprising:
calculating input data of an operation target so as to obtain data of an operation result;
generating statistical information data for indicating a bit distribution in the data of the operation result;
extracting attention area data with a first predetermined size from the statistical information data, based on specified position information;
generating higher-order side summary data obtained by summarizing higher-order side data of the statistical information data except the attention area data into a second predetermined size; and
generating lower-order side summary data obtained by summarizing lower-order side data of the statistical information data except the attention area data into a third predetermined size, by a processor.
